(19) United States
(12) Patent Application Publication
(10) Pub. No.: US 2025/0287942 A1
(43) Pub. Date: Sep. 18, 2025

(54) FORMULATIONS FOR REPELLING BEES AND OTHER INSECTS

(71) Applicants: The Regents of the University of California, Oakland, CA (US); BASF SE, Ludwigshafen am Rhein (DE)

(72) Inventors: Anandasankar RAY, Riverside, CA (US); Joel KOWALEWSKI, Riverside, CA (US); Barbara BAER-IMHOOF, Riverside, CA (US); Matthew LUY, Corona, CA (US); Boris BAR, Riverside, CA (US); Tom Guda OGADA, Moreno Valley, CA (US); Wen XU, Research Triangle Park, NC (US); Rajwinder SINGH, Research Triangle Park, NC (US); Huazhang HUANG, Research Triangle Park, NC (US); Kara Walden BENTON, Research Triangle Park, NC (US); Emir ISLAMOVIC, Davis, CA (US); Henricus Maria Martinus BASTIAANS, Ludwigshafen (DE); Jessica Lee CANONICO, Research Triangle Park, NC (US)

(73) Assignees: The Regents of the University of California, Oakland, CA (US); BASF SE, Ludwigshafen am Rhein (DE)

(21) Appl. No.: 18/858,713

(22) PCT Filed: Apr. 21, 2023
(86) PCT No.: PCT/US2023/019461

§ 371 Date: Oct. 21, 2024

Related U.S. Application Data
(60) Provisional application No. 63/333,469, filed on Apr. 21, 2022.
(60) Provisional application No. 63/397,762, filed on Aug. 12, 2022.

(51) Int. Cl. A01N 37/10; A01N 35/04; A01N 37/18; A01N 43/38; A01N 43/40; A01P 17/00

(52) U.S. Cl. CPC A01N 37/10; A01N 35/04; A01N 37/18; A01N 43/38; A01N 43/40; A01P 17/00

(57) ABSTRACT

The present inventions relates to insect repellent compositions and methods of repelling insects of the order Hymenoptera. Also provided is a method of protecting a crop or crop-containing area. Also provided, is a method of predicting compounds that are repellent to an insect of the order Hymenoptera.

### CROSS-REFERENCE TO RELATED APPLICATIONS

This application claims priority to U.S. Provisional Patent Application Nos. 63/397,762 filed on Aug. 12, 2022, and 63/333,469 filed on Apr. 21, 2022, each of which is hereby incorporated by reference in its entirety.

### FIELD

The present disclosure relates generally to agriculture and biotechnology, and more specifically to an agricultural formulation with odorants in bee safety improvement.

### BACKGROUND

Crop protection products such as pesticides, insecticides, herbicides, and fungicides are important to the world's food production from crops.

Pollinators are also important to the world's food supply from crops. Approximately one-third of the world's food supply from crops relies on pollinators such as bees. However, certain crop protection products such as insecticides and fungicides are toxic to bees.

There is typically a high pest pressure during the flowering stage of crops. Because of the toxicity of certain crop protection products to bees, the majority of crop protection products cannot be applied to crops during the flowering stage.

Further, to ensure our food security, growers need to protect their harvest (e.g. soy, cotton, maize) from insect pests. However, it is illegal to apply insecticides to a flowering crop, in order to protect pollinating honey bees.

### BRIEF SUMMARY

In some aspects, provided herein is an insect repellent composition, wherein the insect is of the order Hymenoptera, the composition comprising: a compound selected from Table 1, or a compound selected from Table 2, or a compound selected from Table 5, or any combination thereof, and at least one carrier vehicle, synergist and/or adjuvant suitable for use in an insect repellent (including, for example, insecticidal sprays).

In some aspects, provided herein is a method of repelling an insect of the order Hymenoptera, comprising: applying any of the compositions described herein to a surface, or a crop, plant or flower, or any part thereof. In other variations, the compositions described herein may be applied to seeds, trees, and soil as exemplary application targets.

In some aspects, provided herein is a method of repelling an insect of the order Hymenoptera, comprising: exposing the insect to any of the compositions described herein to repel the insect.

In some aspects, provided herein is a method of protecting a crop or crop-containing area from crop-damaging pests while repelling an insect of the order Hymenoptera, the method comprising: exposing the crop or crop-containing area to any of the compositions described herein, to repel the insect from making contact with harmful insecticides.

In some aspects, provided herein is a method of predicting compounds that are repellent to an insect of the order Hymenoptera, comprising: screening one or more compounds for one or more physiochemical descriptors selected from Table 3 to generate a molecular descriptor set for each of the one or more compounds; and using the molecular descriptor set to identify compounds that are structurally related to known repellents.

In other aspects, provided is an agricultural bee repellent composition, comprising: a low volatility bee repellent compound; and a high volatility bee repellent compound.

In certain aspects, provided is an agricultural bee repellent composition, comprising: a slow release agricultural bee repellent formulation, comprising a coated or encapsulated bee repellent compound; and a high volatility bee repellent compound.

In one aspect, provided is a slow release agricultural bee repellent composition, comprising a coated or encapsulated bee repellent compound.

In another aspect, provided is a method for repelling bees from crops, comprising applying any of the bee repellent compositions as described herein to a crop or a locus thereof.

### DESCRIPTION OF THE FIGURES

The present application can be understood by reference to the following description taken in conjunction with the accompanying figures.

FIGS. 1A & 1B depict testing chambers containing 1-choice traps to determine whether an odorant will repel male and female fruit flies (Drosophila melanogaster).

FIGS. 2A & 2B depict the 2-choice petri-dish arenas used to expose bees to different repellent candidates.

FIG. 3 depicts the mean percentage of fruit flies (Drosophila melanogaster) caught in a trap treated with potentially repellent odorants (10% in Paraffin oil) and baited with 10% apple cider vinegar.

FIG. 4 depicts preference indexes showing the first choices of honey bee workers (Apis mellifera) offered honey on filter paper with repellent-candidates versus honey only.

FIG. 5A depicts a photograph of the Honeybee Robbing assay.

FIG. 5B depicts the counts of numbers of bees on each frame from videos of the Honeybee Robbing assay represented as a graph.

FIG. 6 depicts the bee tunnel setup used in Example 4.

FIG. 7 depicts the sugar feeding station used in Example 4.

FIG. 8 depicts a graph showing mean % reduction in sugar consumption compared to controls over 10-minute observation period.

FIGS. 9A-9C show the study setup for Example 5.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

Provided herein, are compositions and methods using odorants to protect harvest (e.g. soy, cotton, maize) from insect pests. There is a desire in the art to avoid applying insecticides to a flowering crop, in order to protect pollinating honeybees. To resolve this dilemma, we started developing odorants to repel honey bees. The compositions provided involve co-applying such honey bee repellent odorants together with insecticides, in order to be able to protect crops during flowering season, while at the same time repelling honey bees from visiting the treated crop plants. In one aspect, provided herein is a bee specific repellent. In one aspect, provided herein are formulations for repelling bees from a specific area.

### Insect Repellent Composition

In one aspect, provided herein is an insect repellent composition, wherein the insect is of the order Hymenoptera, the composition comprising:
a compound selected from Table 1, or a compound selected from Table 2, or a compound selected from Table 5, or any combination thereof, and
at least one carrier vehicle, synergist and/or adjuvant suitable for use in an insect repellent.

In some embodiments, the insect is of the order Hymenoptera. In some embodiments, the insect is a bee, wasp, or ant. In certain embodiments, the insect is a honeybee or other pollinators.

In some embodiments, the compound is a compound selected from Table 1, or a compound selected from Table 2, or any combination thereof. In some embodiments, the compound is selected from Table 1. In some embodiments, the compound is selected from Table 2. In other embodiments, the compound is selected from Table 5 (in Example 1 below). It should be understood that, in some variations, any suitable combinations of the compounds disclosed herein, e.g., from Tables 1, 2 and 5, may be used in the compositions.

TABLE 1

| SMILES | Structure | Name |
|---|---|---|
| COCCC(═O)OC1═CC═CC═C1 | 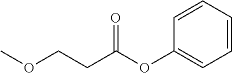 | phenyl 3- methoxypropanoate |
| CCCCCC1═CCCC1═O | 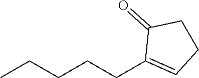 | 2-pentylcyclopent-2-en-1- one |
| COC(═O)C1═C(N═CC═C1)C═C | 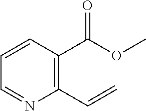 | methyl 2-vinylnicotinate |
| CCCC(═O)CCC1═CC═CC═C1 | 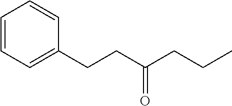 | 1-phenylhexan-3-one or 1-phenyl-3-hexanone |
| CCCCCC(═O)C1═CC═CC═C1 | 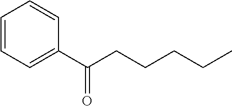 | 1-phenylhexan-1-one or hexanophenone |
| CCCCC(═O)C1═CC═CC═C1 | 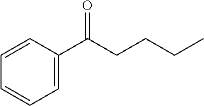 | 1-phenylpentan-1-one |
| CCOC(═O)C1═C(N═CC═C1)C(═O)C | 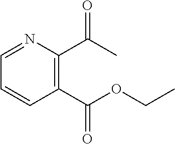 | ethyl 2-acetylnicotinate |
| CCOCCC(═O)N1CCC2═CC═CC═C21 | 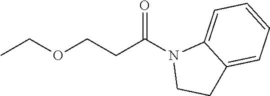 [SMILES: CCOCCC(=O)N1CCc2ccccc21] | 3-ethoxy-1-(indolin-1- yl)propan-1-one |
| CCO[C@@H]1CCCC[C@H]10 | 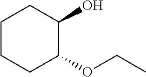 | (1R,2R)-2- ethoxycyclohexan-1-ol |
| CN1CCC2═CC═CC═C21 | 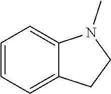 | 1-methylindoline |
| CCC(═O)CC1═CC═CC-C1 | 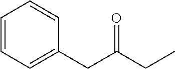 | 1-phenylbutan-2-one |
| C1CNC2═CC═CC═C21 | 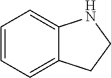 | Indoline |
| CCOC(═O)CC1═CC═CC═C1C | 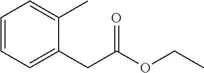 | ethyl 2-(o-tolyl)acetate |
| CCOCCCNC(═O)C1═CC═CC═C1I | 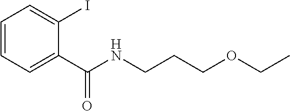 [SMILES: CCOCCCNC(=O)c1ccccc1I] | N-(3-ethoxypropyl)-2- iodobenzamide or N-(3-ethoxypropyl)(2- iodophenyl)carboxamide |
| CCCCOC(═O)C1═C(C═NC2═CC═CC═C21)C | 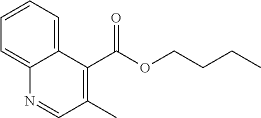 [SMILES: CCCCOC(=O)c1c(C)cnc2ccccc12] | butyl 3-methylquinoline-4- carboxylate |
| CCCNC(═O)C1═CC(═CC═C1)Br | 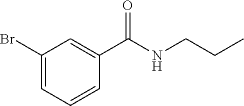 | 3-bromo-N- propylbenzamide |
| CCCCNIC(═O)C2═CC═CC═C2N1 | 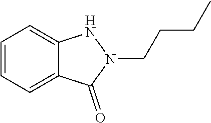 | 2-butyl-1,2-dihydro-3H- indazol-3-one |

TABLE 2

| SMILES | Structure | Name |
|---|---|---|
| CCCC#C | 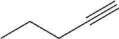 | pent-1-yne |
| [H]CC([H])N1CCCC1═O | 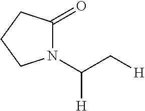 | 1-ethylpyrrolidin-2- one |
| CC[C@@H]1CCCC1═O | 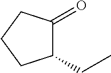 | (R)-2- ethylcyclopenta-1- one |
| CCN(CC)CC#C | 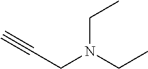 | N,N-diethylprop-2-yn- 1-amine |
| CNC(C)C | 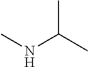 | N-methylpropan-2- amine |
| CN1CCCC1 | 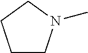 | 1-methylpyrrolidine |
| CCOC(═O)CC(═O)CC | 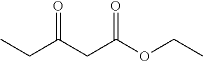 | ethyl 3-oxopentanoate |
| COCCC(═O)OC1═CC═CC═C1 | 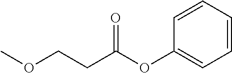 | phenyl 3- methoxypropanoate |
| CC(C)C#C | 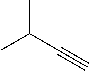 | 3-methylbut-1-yne |
| CCCCCC1═CCCC1═O | 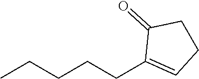 | 2-pentylcyclopent-2- en-1-one |
| CCC(═O)OC1═CC═CC═C1 | 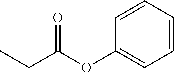 | phenylpropionate |
| CCCCCC#C | 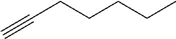 | hept-1-yne |
| CCOC(═O)CC#CC | 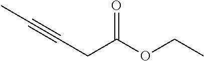 | ethyl pent-3-ynoate |
| COC1CCCCC1═O | 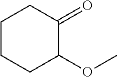 | 2-methoxycyclohexan- 1-one |
| CCOC(═O)CC | 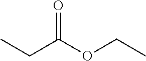 | ethyl propionate |
| CCN1CCCC1 | 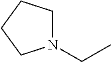 | 1-ethylpyrrolidine |
| CCN(CC)CCN | 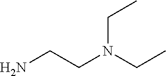 | N1,N1-diethylethane- 1,2-diamine |
| CCCC(═O)CC | 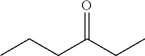 | hexan-3-one |
| COC(C)═O | 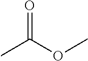 | methyl acetate |
| CCCCC1═CC═CC═C1 | 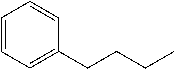 | butylbenzene |
| COC(═O)C1═CC═CN═C1C═C | 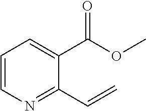 | methyl 2- vinylnicotinate |
| CCCC(═O)CCC1═CC═CC═C1 | 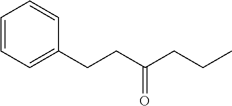 | 1-phenylhexan-3-one |
| CCOC(═O)CCC(C)═O | 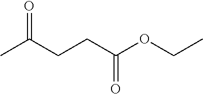 | ethyl 4-oxopentanoate |
| CC(═O)OC1═CC═C(C)C═C1 | 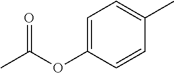 | p-tolyl acetate |
| CCOC1CCCC1═O | 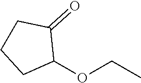 | 2-ethoxycyclopentan- 1-one |
| CCCCCC(═O)C1═CC═CC═C1 | 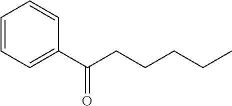 | 1-phenylhexan-1-one |
| CCOC(═O)C1═C(N═CC═C1)C(C)═O | 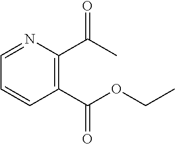 | ethyl 2- acetylnicotinate |
| CC1CCCC1 | 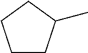 | methylcyclopentane |
| CN1CCC2═C1C═CC═C2 | 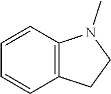 | 1-methylindoline |
| CCOCCC(═O)N1CCC2═C1C═CC═C | 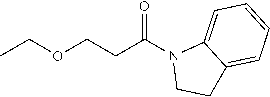 [SMILES: CCOCCC(=O)N1CCc2ccccc21] | 3-ethoxy-1-(indolin-1- yl)propan-1-one |
| CC1═C(CN)C═CC═C1 | 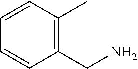 | o-tolylmethanamine |
| CCOC(═O)C1═CC(Br)═CC═C1 | 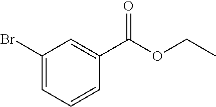 | ethyl 3- bromobenzoate |
| CCCC[C@H](C)C═O | 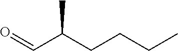 | (S)-2-methylhexanal |
| CC1CCN(C)C1═O | 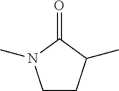 | 1,3- dimethylpyrrolidin-2- one |
| CC(O)C#C | 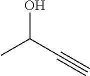 | but-3-yn-2-ol |
| C#CC1CCCCC1 | 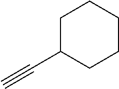 | ethynylcyclohexane |
| COC(═O)C(C)═O | 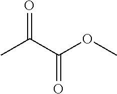 | methyl 2- oxopropanoate |
| CNCCN(C)C | 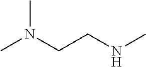 | N1,N1,N2- trimethylethane-1,2- diamine |
| CCCCC(═O)C1═CC═CC═C1 | 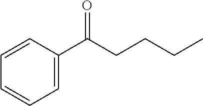 | 1-phenylpentan-1-one |
| CCCCC#CC1═CC═CC═C1 | 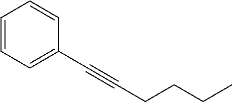 | hex-1-yn-1-ylbenzene |
| CCCCC(C)O | 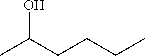 | hexan-2-ol |
| CCN1CCCCC1 | 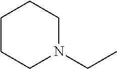 | 1-ethylpiperidine |
| CCC(═O)CC1═CC═CC═C1 | 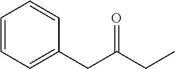 | 1-phenylbutan-2-one |
| CCO[C@@H]1CCCC[C@H]1O | 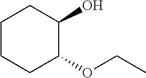 | (1R,2R)-2- ethoxycyclohexan-1-ol |
| CCCCC(═O)CCC | 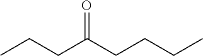 | octan-4-one |
| COCC(C)═O | 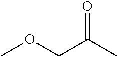 | 1-methoxypropan-2- one |
| C1CC2═C(N1)C═CC═C2 | 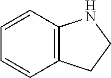 | indoline |
| CCOC(═O)CC1═C(C)C═CC═C1 | 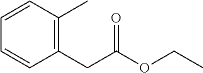 | ethyl 2-(o-tolyl)acetate |
| COC(═O)C1═C(N═CC═C1)C(C)═O | 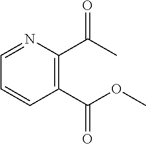 | methyl 2- acetylnicotinate |
| CCOC(═O)C1═CC(C)═CC═C1 | 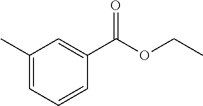 | ethyl 3- methylbenzoate |
| CCOC1(C)CNC1 | 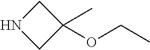 | 3-ethoxy-3- methylazetidine |
| CCCC(OC)OC | 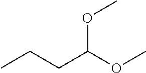 | 1,1-dimethoxybutane |
| CCCC#N | 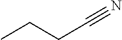 | butyronitrile |
| CCC#N | 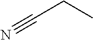 | propiononitrile |
| CCCCC(═O)CC | 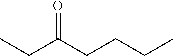 | heptan-3-one |
| CNCC1CCCN1C | 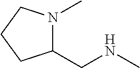 | N-methyl-1-(1- methylpyrrolidin-2- yl)methanamine |
| CCC(C)C(C)═O | 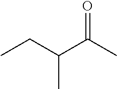 | 3-methylpentan-2-one |
| CO[C@@H]1CCC[C@H]1N | 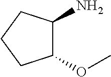 | (1R,2R)-2- methoxycyclopentan- 1-amine |
| CCOC(═O)C(CO)═O | 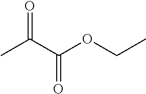 | ethyl 2-oxopropanoate |
| O═C(CCC1CCCC1═O)C1═CC═CC═C1 | 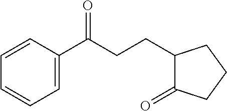 [SMILES: O=C(CCC1CCCC1=O)c1ccccc1] | 2-(3-oxo-3- phenylpropyl)cyclopen- tan-1-one |
| CCCNC(═O)C1═C(C)C═CC═C1 | 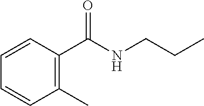 | 2-methyl-N- propylbenzmaide |
| CCC(═O)C1═CC═CC═C1CC | 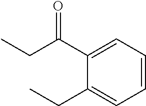 | 1-(2- ethylphenyl)propan-1- one |
| CC(═O)OC1═CC═CC═C1 | 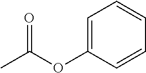 | phenyl acetate |
| CCCC(C)═O | 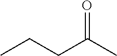 | pentan-2-one |
| COC(═O)CC(C)═O | 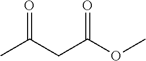 | methyl 3- oxobutanoate |
| C1CCN1CCCC1═O | 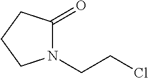 | 1-(2- chloroethyl)pyrrolidin- 2-one |
| COC(CC(C)═O)OC | 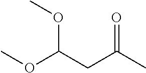 | 4,4-dimethoxybutan- 2-one |
| COCC(═O)C1═CC═CC═C1 | 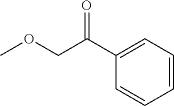 | 2-methoxy-1- phenylethan-1-one |
| CC1═CC═CC(CN)═Cl | 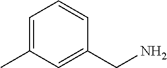 | m-tolylmethanamine |
| C[C@@H]1CCCCN1 | 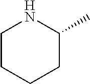 | (R)-2- methylpiperidine |
| ClCCC\C═C/CC1 | 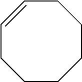 | (Z)-cyclooctene |
| COOC(═O)CC1CCC2═C1C═CC═C2 | 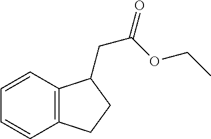 | ethyl 2-(2,3-dihydro- 1H-inden-1-yl)acetate |
| COC(═O)C1═C(C═C)C═NC═C1 | 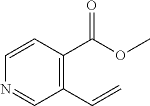 | methyl 3- vinylisonicotinate |
| CCOC(═O)C(CC)C#N | 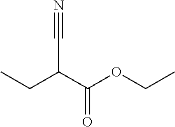 | ethyl 2- cyanobutanoate |
| CCCNCCC | 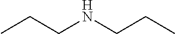 | dipropylamine |
| CCOC(═O)C1═C(C)C═CC═C1 | 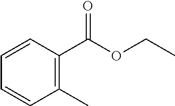 | ethyl 2- methylbenzoate |
| CCOC(═O)C1═C(C)C═CC═C1 | 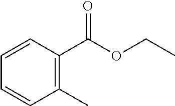 | ethyl 2- methylbenzoate |
| CO[C@@H]1CCCC[C@H]1N | 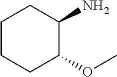 | (1R,2R)-2- methoxycyclohexan-1- amine |
| CCNC(═O)C1═C(C═O)C═CC═C1 | 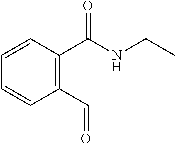 | N-ethyl-2- formylbenzamide |
| CCCC═C | 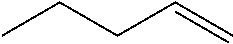 | pent-1-ene |
| CCN(CC)CC#CC | 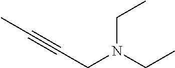 | N,N-diethylbut-2-yn- 1-amine |
| C#CCC1═CC═CC═C1 | 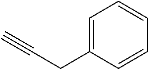 | prop-2-yn-1-ylbenzene |
| CCC1═C(O)C═CC═C1 | 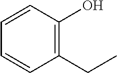 | 2-ethylphenol |
| CCCCCN | 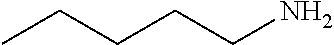 | pentan-1-amine |
| CCCCC(═O)C(C)C | 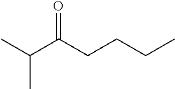 | 2-methylheptan-3-one |
| C(N1CC1)C1═CC═CC═C1 | 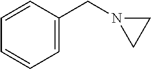 | 1-benzylaziridine |
| CCC(CC)CN | 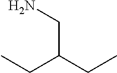 | 2-ethylbutan-1-amine |
| CCOCCC(═O)N(CC)C1═CC═CC═C1 | 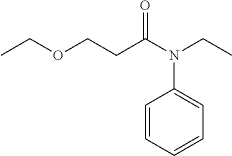 [SMILES: CCOCCC(=O)N(CC)c1ccccc1] | 3-ethoxy-N-methyl-N- phenylpropanamide |
| CCOC(═O)\C═C\C | 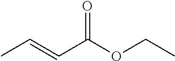 | ethyl (E)-but-2-enoate |
| CCCCCCCC#C | 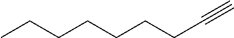 | non-1-yne |
| C[C@H]1CCC[C@H]1O | 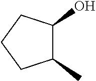 | (1R,2S)-2- methylcyclopentan-1- ol |
| CO[C@@H]1CCCCC[C@H]1N | 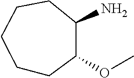 | (1R,2R)-2- methoxycycloheptan- 1-amine |
| COC(═O)C1═CC═CN═C1C | 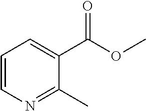 | methyl 2- methylnicotinate |
| CCOC(═O)C1═CC═CC2═C1CNCC2 | 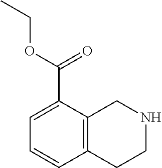 | ethyl 1,2,3,4- tetrahydroisoquinoline- 8-carboxylate |
| CNOC1CCCC1 | 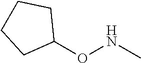 | O-cyclopentyl-N- methylhydroxylamine |
| CC(═O)OCCC1═CC(Br)═CC═C1 | 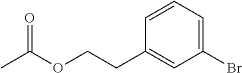 | 3-bromophenethyl acetate |
| CCC#CC1CCCCC1 | 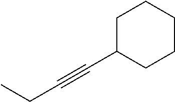 | but-1-yn-1- ylcyclohexane |
| CCCCNC | 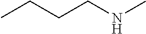 | N-methylbutan-1- amine |
| CCOC(═O)C1═CC(C)═ NC2═CC═CC═C12 | 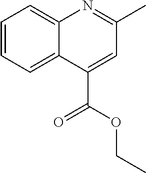 [SMILES: CCOC(=O)c1cc(C)nc2ccccc12] | ethyl 2- methylquinoline-4- carboxylate |
| CCOC(═O)C1═CC2═C(CCO2)C(OC)═C1 | 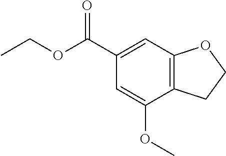 [SMILES: CCOC(=O)c1cc(OC)c2c(c1)OCC2] | ethyl 4-methoxy-2,3- dihydrobenzofuran-6- carboxylate |
| CN(C)CCC1═CC═CC═C1 | 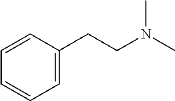 | N,N-dimethyl-2- phenylethan-1-amine |
| CCOC(═O)C1═CC═CC2═NC═CC═C12 | 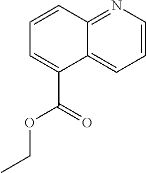 | ethyl quinoline-5- carboxylate |
| CN1CCC(C1)OC(═O)C1═CC═CC═C1 | 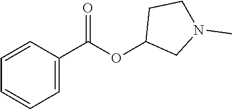 | 1-methylpyrrolidin-3- yl benzoate |
| C#CCN1CCCCC1 | 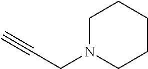 | 1-(prop-2-yn-1- yl)piperidine |
| CC1═NCCCC1 | 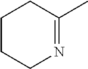 | 6-methyl-2,3,4,5- tetrahydropyridine |
| CCCCN1CCCC1 | 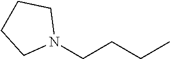 | 1-butylpyrrolidine |
| NC[C@H]1CCCO1 | 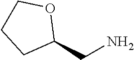 | (R)-(tetrahydrofuran- 2-yl)methanamine |
| CCOCCC(OCC)OCC | 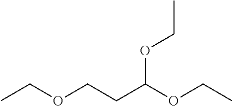 | 1,1,3-triethoxypropane |
| CC[C@@H]1CCC[C@H]1N | 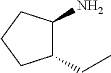 | (1R,2R)-2- ethylcyclopentan-1- amine |
| NCCC1═C(C═CC═C1)C#C | 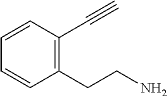 | 2-(2- ethynylphenyl)ethan- 1-amine |
| CO[C@@H]1CCCC[C@H]1O | 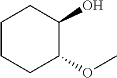 | (1R,2R)-2- methoxycyclohexan-1- ol |
| CCCCCCC(═O)CC | 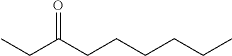 | nonan-3-one |
| O═C(NCC1═CC═CC═C1)N1CCCC1 | 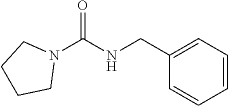 [SMILES: O=C(NCc1ccccc1)N1CCCC1] | N-benzylpyrrolidine- 1-carboxamide |
| CC[C@@H]1CCCN1 | 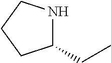 | (R)-2-ethylpyrrolidine |
| CCC1═C(C═CC═N1)C(═O)OC | 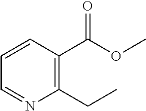 | methyl 2- ethylnicotinate |
| C[C@H]1CCCCN1 | 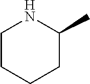 | (S)-2-methylpiperidine |
| CN(C)CC1═CC═CC═C1 | 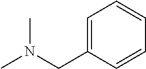 | N,N-dimethyl-1- phenylmethanamine |
| CCC(═O)C1═CC(Br)═CC═C1 | 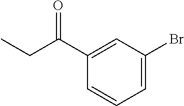 | 1-(3- bromophenyl)propan- 1-one |
| CCCCOCCCC | 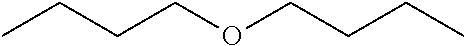 | 1-butoxybutane |
| CCCCCC1═CC═CC═C1 | 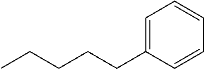 | pentylbenzene |
| CCOC(═O)CCC1═CC═CC═C1CN | 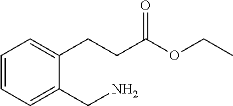 | ethyl 3-(2- (aminomethyl)phenyl) propanoate |
| CCCNCC | 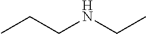 | N-ethylpropan-1- amine |
| COC(═O)CCC(═O)C1═CC═CC═C1OC | 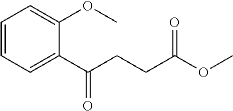 [SMILES: COC(=O)CCC(=O)c1ccccc1OC] | methyl 4-(2- methoxyphenyl)-4- oxobutanoate |
| CC(═O)OC1═CC═C(CC1)C═C1 | 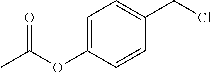 | 4- (chloromethyl)phenyl acetate |
| CCCCCCC═C | 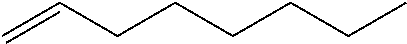 | oct-1-ene |
| CCCNC1═CC═CC═C1 | 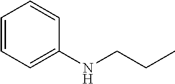 | N-propylaniline |
| CCC(C)═O | 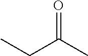 | butan-2-one |
| O═C1CCCC2═CC═CC═C12 | 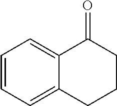 [SMILES: O=C1CCCc2ccccc21] | 3,4- dihydronaphthalen- 1(2H)-one |
| CCOC(═O)CC1CCNC2═C1C═CC═C2 | 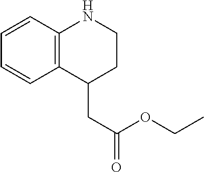 [SMILES: CCOC(=O)CC1CCNc2ccccc21] | ethyl 2-(1,2,3,4- tetrahydroquinolin-4- yl)acetate |
| O═C═NCCC1═CC═CC═Cl | 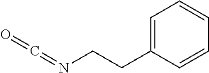 [SMILES: O=C=NCCc1ccccc1] | (2- isocyanatoethyl)benzene |
| NCC1CC1 | 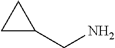 | cyclopropylmethanamine |
| CCNCCN(C)C | 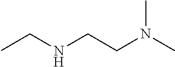 | N1-ethyl-N2,N2- dimethylethane-1,2- diamine |
| O[C@@H]1CCSC1 | 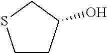 | (R)- tetrahydrothiophen-3- ol |
| COCC(═O)CC(C)═CC#N | 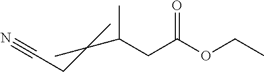 | ethyl 4-cyano-3- methylbut-3-enoate |
| CCCCOC(═O)C1═C(C)C═NC2═ CC═CC═C12 | 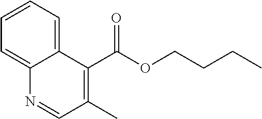 [SMILES: CCCCOC(=O)c1c(C)cnc2ccccc12] | butyl 3- methylquinoline-4- carboxylate |
| CN(C)CCC(═O)C1═CC═CN═C1 | 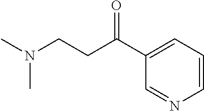 | 3-(dimethylamino)-1- (pyridin-3-yl)propan- 1-one |
| CN1C[C@H]1C1═CC═CC═C1 | 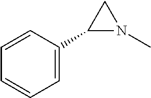 | (R)-1-methyl-2- phenylaziridine |
| CN1C[C@@H]1C1═CC═CC═C1 | 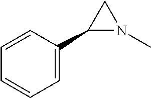 | (S)-1-methyl-2- phenylaziridine |
| CN(C)CCC(═O)C1═CC═CC═C1 | 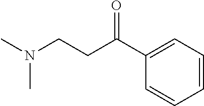 | 3-(dimethylamino)-1- phenylpropan-1-one |
| CO[C@@H]1CC[C@@H]2CNC[C@H]12 | 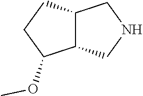 | (3aR,4R,6aS)-4- methoxyoctahydrocyclo- penta[c]pyrrole |
| C#CCOCC1═CC═CC═C1 | 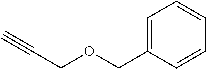 | ((prop-2-yn-1- yloxy)methyl)benzene |
| CCOC(═O)CC1═CC═CN═C1 | 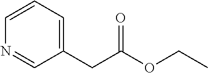 | ethyl 2-(pyridin-3- yl)acetate |
| BrC1═C(CCCC═C)C═CC═C1 | 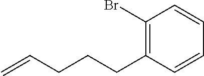 | 1-bromo-2-(pent-4-en- 1-yl)benzene |
| CC1CCCCN1 | 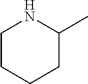 | 2-methylpiperidine |
| CCOC(═O)CC1═C(Br)C═CC═C1 | 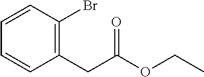 | ethyl 2-(2- bromophenyl)acetate |
| CCCCOC(═O)C1═CC═CC═C1 | 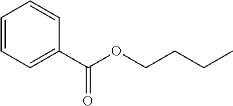 | butyl benzoate |
| CCC(O)C#C | 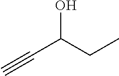 | pent-1-yn-3-ol |
| CCCCC(═O)CC1═CC═CC═C1 | 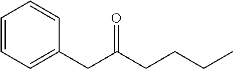 | 1-phenylhexan-2-one |
| CCOC(═O)C1═CC═CC2═C1CCN2 | 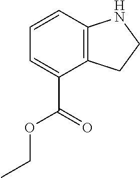 | ethyl indoline-4- carboxylate |
| C1CCCC1 | 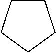 | cyclopentane |
| COC(═O)C1CC1 | 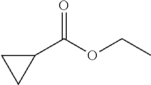 | ethyl cyclopropanecarboxylate |
| CC1N(C)CCC1═O | 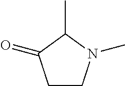 | 1,2- dimethylpyrrolidin-3- one |
| CC1CC1NC1═CC═CC═C1 | 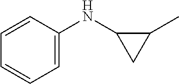 | N-(2- methylcyclopropyl)ani- line |
| CCOC(═O)CC1═CCC2═C1C═CC═C2 | 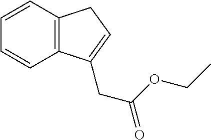 | ethyl 2-(1H-inden-3- yl)acetate |
| CCCCCC#N | 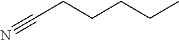 | hexanenitrile |
| COC1═C(Br)C═C(OC(C)═O)C═C1 | 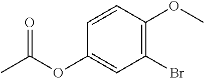 | 3-bromo-4- methoxyphenyl acetate |
| CCOCCOC(═O)C1═CC═CC═C1 | 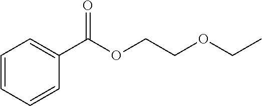 | 2-ethoxyethyl benzoate |
| CC(═O)CC(═O)OCC═C | 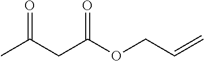 | allyl 3-oxobutanoate |
| COC(═O)C1═C(C═O)C═C(Br)C═C1 | 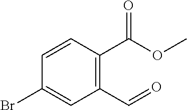 | methyl 4-bromo-2- formylbenzoate |
| CC(C)OC1═C(OCCN(C)C)C═CC═C1 | 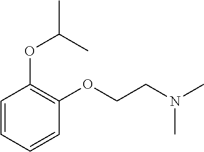 [SMILES: CC(C)Oc1ccccc1OCCN(C)C] | 2-(2- isopropoxyphenoxy)- N,N-dimethylethan-1- amine |
| CC1═NCCC2═CC═CC═C12 | 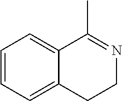 | 1-methyl-3,4- dihydroisoquinoline |
| CC(═O)OC(C)═C1C═CC═C1 | 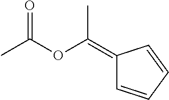 | 1-(cyclopenta-2,4- dien-1-ylidene)ethyl acetate |
| COC(═O)\C═C\C | 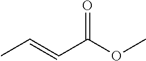 | methyl (E)-but-2- enoate |
| CCOC(═O)C(Br)CC | 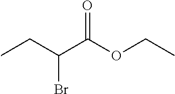 | ethyl 2- bromobutanoate |
| CCOCC(═O)N1CCCC2═C1C═CC═C2 | 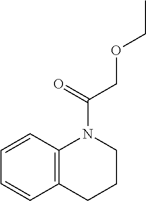 [SMILES: CCOCC(=O)N1CCCc2ccccc21] | 1-(3,4- dihydroquinolin- 1(2H)-yl)-2- ethoxyethan-1-one |
| CCSCCOC(═O)C1═CC═CC═C1C#N | 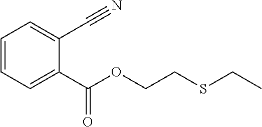 [SMILES: CCSCCOC(=O)c1ccccc1C#N] | 2-(ethylthio)ethyl 2- cyanobenzoate |
| CC1CC2═C(O1)C═CC═C2 | 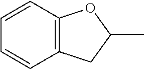 | 2-methyl-2,3- dihydrobenzofuran |
| CCOC1═CC═CC═C1C (═O)O[C@H]1CCOC1 | 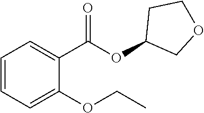 [SMILES: CCOc1ccccc1C(=O)O[C@H]1CCOC1] | (S)-tetrahydrofuran-3- yl 2-ethoxybenzoate |
| CCOC(═O)C1═CC═CC2═CC═CC═C12 | 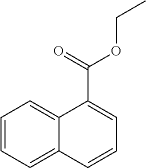 | ethyl 1-naphthoate |
| CN[C@@H]1CCCN(C)C1 | 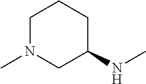 | (R)-N,1- dimethylpiperidin-3- amine |
| CCOCC(═O)CC(C)═O | 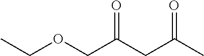 | 1-ethoxypentane-2,4- dione |
| C(C1CO1)C1═CC═CC═C1 | 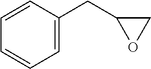 | 2-benzyloxirane |
| CCCCC(═O)NC1═C(CC)C═CC═C1 | 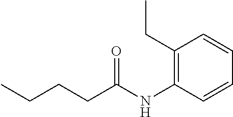 | N-(2- ethylphenyl)pentanamide |
| CCNC(═O)C1═CC(Br)═CC═C1 | 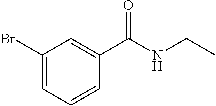 | 3-bromo-N- ethylbenzamide |
| O═C(N1CCCC1)C1═CN═CC═C1 | 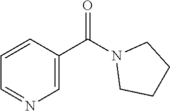 [SMILES: O=C(c1cccnc1)N1CCCC1] | pyridin-3- yl(pyrrolidin-1- yl)methanone |
| CCOC(CC1═CC═CN═C1)OCC | 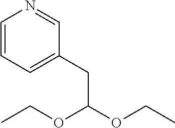 | 3-(2,2- diethoxyethyl)pyridine |
| CCCCC(═O)OC1═CC═CC═C1CC | 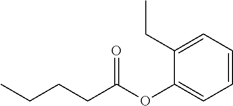 | 2-ethylphenyl pentanoate |
| C[14C]1═[14CH][14CH]═[14CH] [14CH]═[14CH]1 | 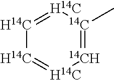 | toluene-1,2,3,4,5,6- 14C6 |
| CC(═O)C1═CC═CC═C1C | 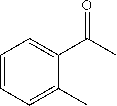 | 1-(o-tolyl)ethan-1-one |
| CCC(═O)C(C)S | 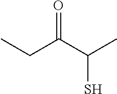 | 2-mercaptopentan-3- one |
| NCCN1CCCCC1 | 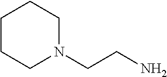 | 2-(piperidin-1- yl)ethan-1-amine |
| FC1═CC═CC═C1CCC(═O)N1CCCC1 | 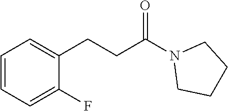 [SMILES: O=C(CCc1ccccc1F)N1CCCC1] | 3-(2-fluorophenyl)-1- (pyrrolidin-1- yl)propan-1-one |
| CCCCC(═O)NC1═C(C)C═CC═C1CC | 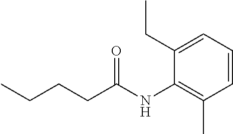 [SMILES: CCCCC(=O)Nc1c(C)cccc1CC] | N-(2-ethyl-6- methylphenyl)pentana- mide |
| CCC(═O)CCC1═CC═CC═C1 | 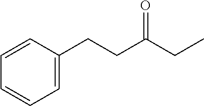 | 1-phenylpentan-3-one |
| C1CCCCC1 | 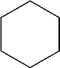 | cyclohexane |
| CC1═C(CC#N)C═CC═C1 | 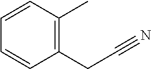 | 2-(o-tolyl)acetonitrile |
| CCCC(═O)C1═CC(C)═CC═C1 | 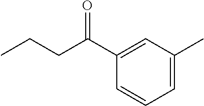 | 1-(m-tolyl)butan-1- one |
| CCOC(═O)C1CC1C | 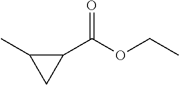 | ethyl 2- methylcyclopropane- 1-carboxylate |
| CCOC(═O)[C@@H]1C[C@H]1C | 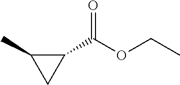 | ethyl (1R,2R)-2- methylcyclopropane- 1-carboxylate |
| CCOC(═O)C═CCC1 | 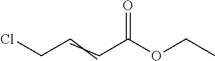 | ethyl 4-chlorobut-2- enoate |
| CCOC(═O)C1═CC═CN═C1CC1 | 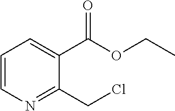 | ethyl 2- (chloromethyl)nicotinate |
| CCC1═CC═C(C)C═C1 | 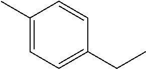 | 1-ethyl-4- methylbenzene |
| BrCCCCCCOC1═CC═CC═C1 | 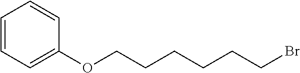 [SMILES: BrCCCCCCOc1ccccc1] | ((6- bromohexyl)oxy)benzene |
| CCC(CC)CCO | 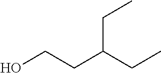 | 3-ethylpentan-1-ol |
| CCC(═O)C1═CC(C)═CC═C1 | 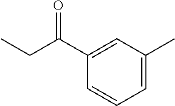 | 1-(m-tolyl)propan-1- one |
| CCOCC(C)C | 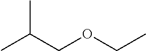 | 1-ethoxy-2- methylpropane |
| CCNC1═CC═C(C)C═C1C(═O)OCC | 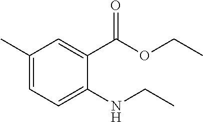 | ethyl 2-(ethylamino)- 5-methylbenzoate |
| CC(C)OCC1═CC═CC═C1 | 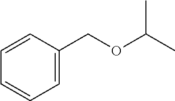 | (isopropoxymethyl)ben- zene |
| CCOCCCNC(═O)C1═CC(C)═CC═C1 | 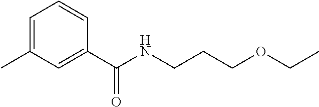 [SMILES: CCOCCCNC(=O)c1cccc(C)c1] | N-(3-ethoxypropyl)-3- methylbenzamide |
| CCC\C═C\CC | 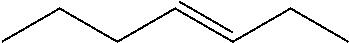 | (E)-hept-3-ene |
| CN[C@@H]1CCCC[C@H]1N | 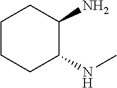 | (1R,2R)-N1- methylcyclohexane- 1,2-diamine |
| C1CC2═C(C1)C═CC═C2 | 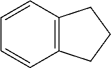 | 2,3-dihydro-1H- indene |
| CN1NC2═CC═CC═C2C1═O | 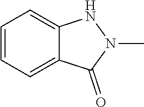 | 2-methyl-1,2-dihydro- 3H-indazol-3-one |
| CSCCC(═O)N1CCC2═CC═CC═C12 | 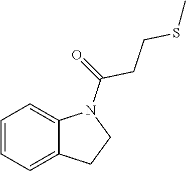 | 1-(indolin-1-yl)-3- (methylthio)propan-1- one |
| CCOC(═O)CCC1═CC═CC═C1 | 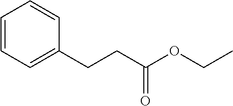 | ethyl 3- phenylpropanoate |
| CCCOC(═O)C1═CC═CC═C1 | 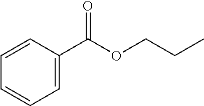 | propyl benzoate |
| CN1CCC(CC1)NC(═O)C1═CC═CC═C1 | 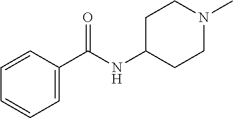 [SMILES: CN1CCC(NC(=O)c2ccccc2)CC1] | N-(1-methylpiperidin- 4-yl)benzamide |
| CCOC(CC1═CC(Br)═CC═C1)OCC | 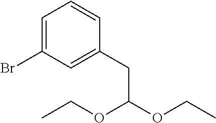 | 1-bromo-3-(2,2- diethoxyethyl)benzene |
| CC(═O)OC1═CC═CC(═C1)C(C)═O | 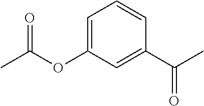 | 3-acetylphenyl acetate |
| C[C@H]1OCC[C@H]1CO | 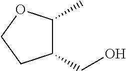 | ((2R,3S)-2- methyltetrahydrofuran- 3-yl)methanol |
| CCCCCCC#C | 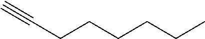 | oct-1-yne |
| CCCCCCCCC═C | 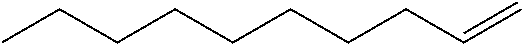 | dec-1-ene |
| CC#CC1CCCCC1 | 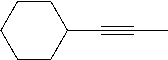 | prop-1-yn-1- ylcyclohexane |
| COC(═O)C1═C(C═CC═C1)C(C)═O | 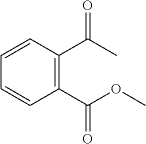 | methyl 2- acetylbenzoate |
| CC1═C(C═CC═C1)C(═O)NCC═C | 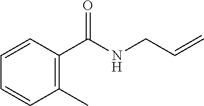 | N-allyl-2- methylbenzamide |
| SCCCCOC1═C(Br)C═CC═C1 | 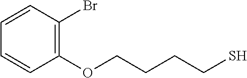 [SMILES: SCCCCOc1ccccc1Br] | 4-(2- bromophenoxy)butane- 1-thiol |
| CCOC(═O)C1═C(C)N═CC═C1 | 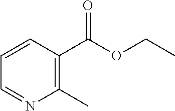 | ethyl 2- methylnicotinate |
| CCOC1═C(CC#N)C═CC═C1 | 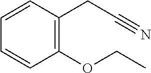 | 2-(2- ethoxyphenyl)acetonitrile |
| C#CCCC1═CC═CC═C1 | 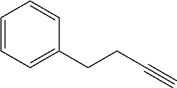 | but-3-yn-1-ylbenzene |
| CCOCC1═CC═CC═C1 | 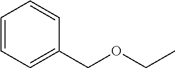 | (ethoxymethyl)benzene |
| CCOC(═O)CC1═CC═CC═C1 | 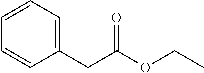 | ethyl 2-phenylacetate |
| CCOC(═O)C1═NNC2═CC═CC(OC)═C12 | 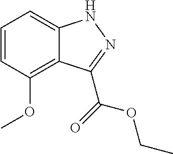 [SMILES: CCOC(=O)c1n[nH]c2cccc(OC)c12] | ethyl 4-methoxy-1H- indazole-3-carboxylate |
| CCOC(═O)C1═CC═C(C)C═C1Br | 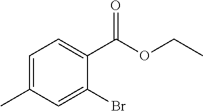 | ethyl 2-bromo-4- methylbenzoate |
| OCC1CCC1═O | 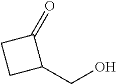 | 2- (hydroxymethyl)cyclo- butan-1-one |
| CN1CCCNCC1 | 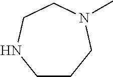 | 1-methyl-1,4- diazepane |
| CC(═O)OC1═CNC2═CC═CC═C12 | 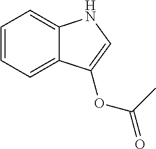 | 1H-indol-3-yl acetate |
| CCOCCCNC(═O)CC1═CC═CC═C1C | 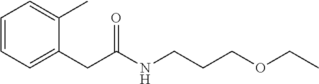 [SMILES: CCOCCCNC(=O)Cc1ccccc1C] | N-(3-ethoxypropyl)-2- (o-tolyl)acetamide |
| CCC1═C(OC)C═CC═C1 | 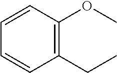 | 1-ethyl-2- methoxybenzene |
| CCC1═CC═CC═C1CC#N | 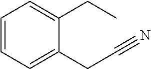 | 2-(2- ethylphenyl)acetonitrile |
| CC(═O)CCC1═CC═CC═C1 | 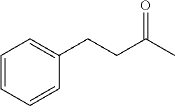 | 4-phenylbutan-2-one |
| COC(═O)CC1═CC(CC1)═CC═C1 | 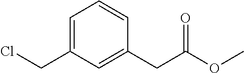 | methyl 2-(3- (chloromethyl)phenyl) acetate |
| NCCCCN1CCCC1 | 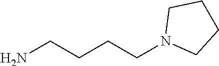 | 4-(pyrrolidin-1- yl)butan-1-amine |
| NC1CCC1 | 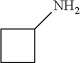 | cyclobutanamine |
| C1CCCCCOC(═O)C1═CC═CC═C1 | 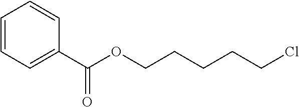 [SMILES: O=C(OCCCCCCl)c1ccccc1] | 5-chloropentyl benzoate |
| NCCN1CCCC1 | 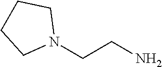 | 2-(pyrrolidin-1- yl)ethan-1-amine |
| COC(═O)C(C)C(C)═O | 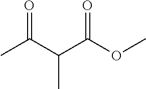 | methyl 2-methyl-3- oxobutanoate |
| NCCC1CCCC1 | 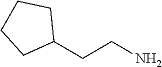 | 2-cyclopentylethan-1- amine |
| [C@@H ]1CC2═C(N1)C═CC═C2 | 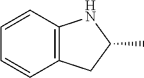 | (R)-2-methylindoline |
| CCOC(═O)C(═O)C1═CC═CC═C1 | 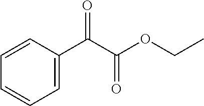 | ethyl 2-oxo-2- phenylacetate |
| C[C@H]1CC2═C(N1)C═CC═C2 | 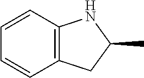 | (S)-2-methylindoline |
| COC1CCCC(═O)CC1 | 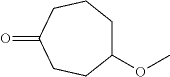 | 4- methoxycycloheptane- 1-one |
| CCOCCCNC(═O)C1═C(I)C═CC═C1 | 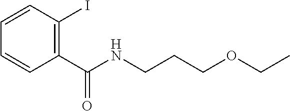 [SMILES: CCOCCCNC(=O)c1ccccc1I] | N-(3-ethoxypropyl)-2- iodobenzamide |
| CSCCC(═O)OC1═CC═CC═C1 | 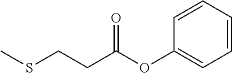 | phenyl 3- (methylthio)propanoate |
| CCCCCCN | 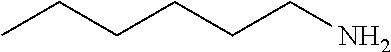 | hexan-1-amine |
| CCC1═CC═C(C═C1)C (═O)C1═CC═CC═C1 | 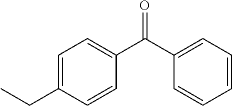 [SMILES: CCc1ccc(C(=O)c2ccccc2)cc1] | (4- ethylphenyl)(phenyl)meth- anone |
| COC(OC)C1═CC═CC═C1 | 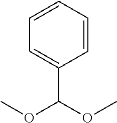 | (dimethoxymethyl)ben- zene |
| CNC1═NC2═CC═CC═C2C(═C1) (C(═O)OC | 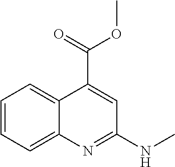 [SMILES: CNc1cc(C(=O)OC)c2ccccc2n1] | methyl 2- (methylamino)quinoline- 4-carboxylate |
| CCOC(═O)COC1═C(Br)C═CC═C1 | 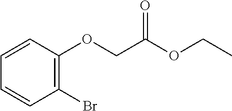 | ethyl 2-(2- bromophenoxy)acetate |
| CCOC(═O)CC1═CC═NC═C1 | 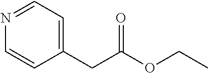 | ethyl 2-(pyridin-4- yl)acetate |
| CCOC(C)(C)CC | 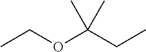 | 2-ethoxy-2- methylbutane |
| CC(═O)C1═CNC═C1C | 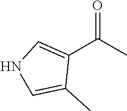 | 1-(4-methyl-1H- pyrrol-3-yl)ethan-1- one |
| CCCC(═O)NC1═C(C═CC═C1) C1═CC═CC═C1 | 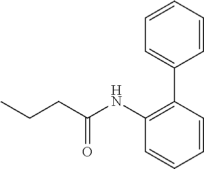 [SMILES: CCCC(=O)Nc1ccccc1-c1ccccc1] | N-([1,1′-biphenyl]-2- yl)butyramide |
| BrC1═CC═CC(═C1)C(═O)CCC#N | 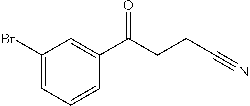 [SMILES: N#CCCC(=O)c1cccc(Br)c1] | 4-(3-bromophenyl)-4- oxobutanenitrile |
| CCN(CC)CC#N | 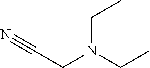 | 2- (diethylamino)acetonitrile |
| CCN(CC)CC(C)═O | 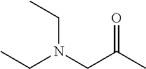 | 1- (diethylamino)propan- 2-one |
| CCC(═O)NC1═CC(C)═CC═C1 | 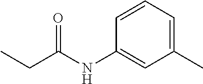 | N-(m- tolyl)propionamide |
| CN1CCCN═C(C2═CC═CC═C2)C1═O | 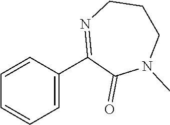 | 1-methyl-3-phenyl- 1,5,6,7-tetrahydro-2H- 1,4-diazepin-2-one |
| CCCCN | 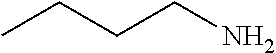 | butan-1-amine |
| CCOC═C1C(═O)C2═CC═CC═C2C1═O | 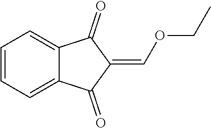 | 2-(ethoxymethylene)- 1H-indene-1,3(2H)- dione |
| CC(C)OCCCC#C | 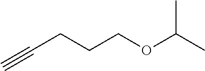 | 5-isopropoxypent-1- yne |
| CN1CCCC(N)C1 | 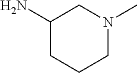 | 1-methylpiperidin-3- amine |
| CC(═O)OC1═C2C═CNC2═CC═C1 | 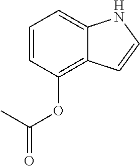 | 1H-indol-4-yl acetate |
| CCOC(═O)C1═C(C═CC═C1)C(C)═O | 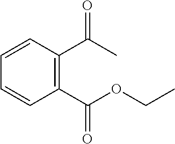 | ethyl 2-acetylbenzoate |
| CN(CC#C)CC1═CC═CC═C1 | 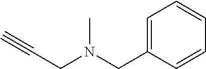 | N-benzyl-N- methylprop-2-yn-1- amine |
| COC(C)[C@H ](C)CN | 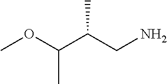 | (2R)-3-methoxy-2- methylbutan-1-amine |
| CCOC(OCC)OC1═CC═CC═C1 | 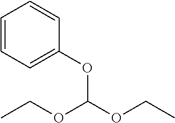 | (diethoxymethoxy)ben- zene |
| CCN(CC)C(═O)C1═CC═CC═C1 | 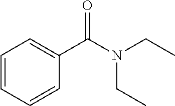 | N,N-diethylbenzamide |
| CCN(CC)CCNC | 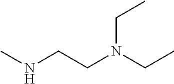 | N1,N1-diethyl-N2- methylethane-1,2- diamine |
| CCCC(═O)C1═CC═CC═C1 | 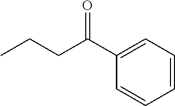 | 1-phenylbutan-1-one |
| CC(═O)C1═CC═CC═C1\C═C\ C1═CC═CC═C1 | 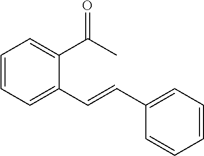 [SMILES: CC(=O)c1ccccc1/C=C/c1ccccc1] | (E)-1-(2- styrylphenyl)ethan-1- one |
| CCCCC(═O)C1═CC═C(C)C═C1 | 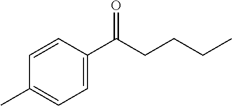 | 1-(p-tolyl)pentan-1- one |
| CCOCCCNC(═O)C1═CC═CC═C1 | 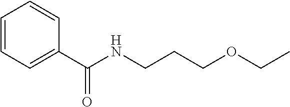 | N-(3- ethoxypropyl)benzamide |
| CCCCN1NC2═CC═CC═C2C1═O | 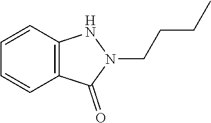 | 2-butyl-1,2-dihydro- 3H-indazol-3-one |
| CCCCNC(═O)C1═CC(C)═C(C)C═C1 | 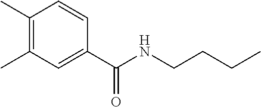 | N-butyl-3,4- dimethylbenzamide |
| CCC1═C(C)C═CC(C)═C1 | 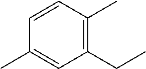 | 2-ethyl-1,4- dimethylbenzene |
| CC(═O)OC1═CC═CC═C1F | 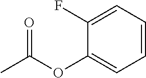 | 2-fluorophenyl acetate |
| CN(C)CCCN | 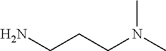 | N1,N1- dimethylpropane-1,3- diamine |
| CCOC1═C(OCC#CCNC)C═CC═C1 | 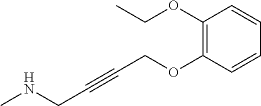 [SMILES: CCOc1ccccc1OCC#CCNC] | 4-(2-ethoxyphenoxy)- N-methylbut-2-yn-1- amine |
| CCOC(═O)C1═C(I)C═CC═C1 | 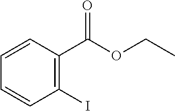 | ethyl 2-iodobenzoate |
| CCCN1CCC[C@H]1CN | 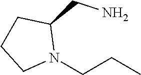 | (S)-(1- propylpyrrolidin-2- yl)methanamine |
| CO[C@@H]1COC[C@H ]1O | 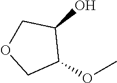 | (3R,4R)-4- methoxytetrahydrofuran- 3-ol |
| O═C(OCCC#N)C1═CC═CC═C1 | 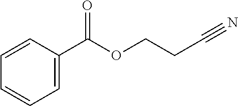 [SMILES: N#CCCOC(=O)c1ccccc1] | 2-cyanoethyl benzoate |
| COC(C)[C@@H](C)CN | 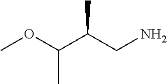 | (2S)-3-methoxy-2- methylbutan-1-amine |
| CO[C@@H]1CNCC[C@H]1C | 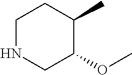 | (3S,4R)-3-methoxy-4- methylpiperidine |
| CCCNC(═O)C1═CC(Br)═CC═C1 | 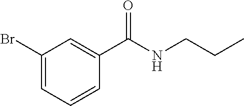 | 3-bromo-N- propylbenzamide |
| CCOC1═C(C═CC═C1)C(C1)═O | 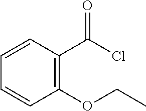 | 2-ethoxybenzoyl chloride |
| CCNCCOC1═C (OCC2═CC═CC═C2)C═CC═C1 | 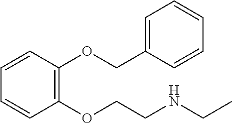 [SMILES: CCNCCOc1ccccc1OCc1ccccc1] | 2-(2- (benzyloxy)phenoxy)- N-ethylethan-1-amine |
| NC[C@@H]1CCCO1 | 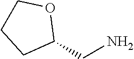 | (S)-(tetrahydrofuran- 2-yl)methanamine |
| CCOC(═O)C1═C(OC═N1) C1═CC═CC═C1 | 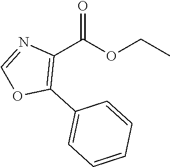 [SMILES: CCOC(=O)c1ncoc1-c1ccccc1] | ethyl 5- phenyloxazole-4- carboxylate |
| CCCCC | 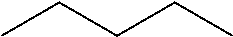 | pentane |
| CCO\C═C1/C(═O)N(CC)C2═C1C═CC═C2 | 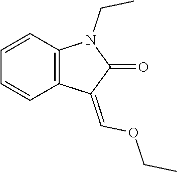 [SMILES: CCO/C=C1\C(=O)N(CC)c2ccccc21] | (Z)-3- (ethoxymethylene)-1- ethylindolin-2-one |
| CCCCCC1═NC═CC═C1 | 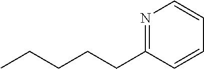 | 2-pentylpyridine |
| CCCCCCC(═O)CCC | 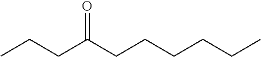 | decan-4-one |
| COC1CNCCC1C | 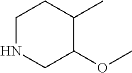 | 3-ethoxy-4- methylpiperidine |
| CCCCC(C)═O | 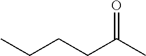 | hexan-2-one |
| COC(═O)C1═CC═CO1 | 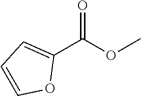 | methyl furan-2- carboxylate |
| CCOCC1═CC═C(C)C═C1 | 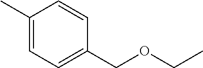 | 1-(ethoxymethyl)-4- methylbenzene |
| NC[C@H]1CCNC1 | 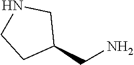 | (R)-pyrrolidin-3- ylmethanamine |
| BrC1CCCCCC1 | 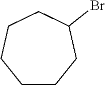 | bromocycloheptane |
| CCOC(CO)C1CC1 | 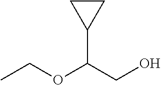 | 2-cyclopropyl-2- ethoxyethan-1-ol |
| COC(═O)C1═C(OC═C1)C═O | 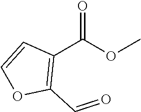 | methyl 2-formylfuran- 3-carboxylate |

In another aspect, provided herein is an insect repellent composition, wherein the insect is of the order Hymenoptera, the composition comprising:
a compound selected from ethyl m-tolylacetate, 3-bromo-N-ethylbenzamide, N-(3-ethoxypropyl)(2-iodophenyl)carboxamide, ethyl 2-iodobenzoate, ethyl 2-(2,3-dihydro-1H-inden-1-yl)acetate, hexanophenone, phenyl 3-methoxypropanoate, 1-phenyl-3-hexanone, (2E)-1,3-diphenyl-2-buten-1-on, 1-(2,3-dihydro-1H-indol-1-yl)-3-ethoxy-1-propanone, 3-(3-pyridinyl)-1-(4-pyridinyl)-2-propen-1-one, 2-isopropoxy-1,2-diphenylethanone, ethyl 2-(o-tolyl)acetate, 1-methylindoline, or (1R,2R)-2-ethoxycyclohexanol, or any combination thereof; and
at least one carrier vehicle, synergist and/or adjuvant suitable for use in an insect repellent.

In some embodiments, the compound is ethyl m-tolylacetate, 3-bromo-N-ethylbenzamide, N-(3-ethoxypropyl)(2-iodophenyl)carboxamide, ethyl 2-iodobenzoate, ethyl 2-(2,3-dihydro-1H-inden-1-yl)acetate, hexanophenone, phenyl 3-methoxypropanoate, 1-phenyl-3-hexanone, (2E)-1,3-diphenyl-2-buten-1-on, 1-(2,3-dihydro-1H-indol-1-yl)-3-ethoxy-1-propanone, 3-(3-pyridinyl)-1-(4-pyridinyl)-2-propen-1-one, or 2-isopropoxy-1,2-diphenylethanone, or any combination thereof. In some embodiments, the compound is ethyl 2-(o-tolyl)acetate, 1-methylindoline, hexanophenone, ethyl 2-(2,3-dihydro-1H-inden-1-yl)acetate, N-(3-ethoxypropyl)(2-iodophenyl)carboxamide, (1R,2R)-2-ethoxycyclohexanol, 1-phenyl-3-hexanone, or phenyl 3-methoxypropanoate, or any combination thereof. In some embodiments, the compound is ethyl 2-(2,3-dihydro-1H-inden-1-yl)acetate, N-(3-ethoxypropyl)(2-iodophenyl)carboxamide, ethyl 2-(o-tolyl)acetate, or any combination thereof.

In some embodiments, the compound is of low volatility.

In some embodiments, the compound is present at a concentration between 0.01 to 30% in the composition.

In some embodiments, the composition further comprises at least one insecticide, fungicide, herbicide, and/or seed treatment products.

In certain embodiments, the composition further comprises at least one insecticide. In some embodiments, the insecticide is a known active insecticide. In some embodiments, at least one insecticide comprises pyrethrum; Sodium Lauryl Sulfate; Rosemary Oil; Peppermint Oil; Thyme Oil; Cinnamon Oil; Garlic Oil; Clove Oil; Cedar Wood Oil; 1% Spearmint Oil; Neem Oil; Sumithrin; d-Phenothrin; Prallethrin; Deltamethrin; Fipronil; Hydramethylnon; Hydroprene; Methoprene; pyriproxyfen; Diatomaceous Earth; d-Phenothrin, N-Octyl Bicyclopheptene Dicarboximide; Imidacloprid, 1% n-Octyl bicycloheptene dicarboximide; d-Phenothrin; Clothianidin; Metofluthrin; (S)-methoprene; Pyriproxyfen; Flumethrin; Selamectin; Dinotefuran; Spinetoram; Fluralenar; Indozacarb; coumaphos; piperonyl butoxide; cyfluthrin; Acramite (bifenazate); Aldicarb; Asana XL (esfenvalerate); Bacillus thuringiensis (bacterium); Baythroid (cyfluthrin); Beta-cyfluthrin (pyrethyroid); Carbaryl (carbamate); carbofuran; Chlorpyrifos (organophosphate); Cruiser 5FS (thiamethoxam); Cygon 400 (dimethoate); Cythion 57% (malathion); Diazinon (organophosphate); Dibrom 8E; Dimethoate (organophosphate); Dimilin (diflubenzuron); Dipel 2X; Endosulfan (organochlorine); Esfenvalerate (pyrethroid); Fulfill (pymetrozine); Gama- and Lamda-cyhalothrin (pyrethroid); Guthion (azinphos methyl); Idoxacard (carboxylate); Imidan (phosmet); Kelthane (dicofol); Lanate (methomyl); Malathion (organophosphate); Metasystox-R; Methidathion (organophosphate); Methomyl (carbamate); Methoxychlor (methoxychlor); Methyl parathion (organophosphate); MSR (oxydemeton-methyl); Mustang Max (pyrethroid); Neemix; Nufos 4E (chlorpyrifos); Parathion 4E; Permethrin; Phosmet (organophosphate); Provado (imidacloprid); Pyrethrins; Sevin (carbaryl); Telfluthrin; Temik (aldicarb; terbufos; Thiodan (endosulfan); Vendex (hexakis fenbutatin-oxide); Warrior (organophosphate); Zeal (etoxazole); Zolone 3EC; Zeta-Cypermethrin; Sulfur; Spinosad (spinosyn A and spinosad D); Potassium Salts of Fatty Acids; Bifenthrin; cypermethrin; tebuconazole; tau-fluvalinate; carabryl; or insectidal soap, or any combination thereof. In other embodiments, the insecticides are selected from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, and rotenone, or their derivatives.

In certain embodiments, the composition further comprises at least one herbicide. In some embodiments, the herbicide is a known active herbicide. In some embodiments, the herbicides are selected from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, and ureas.

In certain embodiments, the composition further comprises at least one fungicide. In some embodiments, the fungicide is a known active fungicide. In some embodiments, the fungicides are selected from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, and triazoles.

In some variations, the compositions provided further comprise at least one carrier vehicle. Any suitable carrier vehicles, e.g., for agricultural use, including in some variations for insecticidal sprays, may be used. Examples of carrier vehicles may include, for example, gels, liquids, dips, pastes, sprays, and aerosols. In certain variations, the carrier vehicle comprises an oil. Examples of suitable oils include linseed oil, castor oil, and vegetable oils, such as for example safflower oil, sunflower oil, canola oil, soybean oil, and peanut oil, and combinations thereof.

In some variations, the compositions provided further comprise at least one synergist. Synergists suitable for use in such compositions may include commercially available chemicals that make insecticide ingredients more effective at killing pests, while being low in toxicity for humans. Insecticide synergists may include, for example, piperonyl butoxide and n-octyl bicycloheptane dicarboximide.

In some variations, the compositions provided further comprise at least one adjuvant. Adjuvants suitable for use in such composition may include commercially available substances that made be added to enhance the performance and/or physical properties of the compositions, e.g., formulated as a spray mixture. In certain variations, the adjuvant comprises surfactants, emulsifiers, oils and salts. In one variation, the adjuvant comprises nonionic surfactants and/or buffering agent that improves spray coverage and uptake. In another variation, the adjuvant may be a low foaming, spreader-activator with buffering agents.

In other variations, the compositions provided further comprise one or more additives. In one variation, the additive is a preservative, a colorant, a stabilizer, a fragrance, or a combination thereof.

In some embodiments, the compositions provided herein are formulated or formatted for agricultural use. For example, in some variations. suitable formulations and formats may include aerosol, bait, dust, dry flowable, emulsifiable concentrate, flowable, granule, microencapsulation, pellet, ready-to-use, soluble powder, ultra-low-volume concentrate, wettable powder, and water-dispersible granule. In other variations, suitable formulations and formats may include oil-in-water emulsions, concentrated suspensions, suspoemulsions, encapsulation and suspension mixtures, oil dispersions, seed treatment suspensions, seed coatings, and dispersible concentrates.

In other embodiments, the composition is formulated as a spray, lotion, dust, paste, slow-release granule, paint, treated netting, treated building material, or incense. In some embodiments, the composition is formulated for exposure using a vaporizer, evaporator, fan, heat, candle, or wicked apparatus.

### Methods of Use

In one aspect, provided herein is a method of repelling an insect of the order Hymenoptera, comprising: applying the composition of any one of claim, or a crop, plant or flower, or any part thereof.

In some embodiments, the composition is applied by spraying. In other embodiments, chemigation, coating, and injecting are other suitable methods of application, as well as in-furrow, drone, and aerial applications and bait stations.

In one aspect, provided herein is a method of repelling an insect of the order Hymenoptera, comprising: exposing the insect to the insect repelling composition of the present disclosure to repel the insect.

In one aspect, provided herein is a method of protecting a crop or crop-containing area from crop-damaging pests while repelling an insect of the order Hymenoptera, the method comprising: exposing the crop or crop-containing area to the insect repellent composition of the present disclosure, to repel the insect from making contact with harmful insecticides.

In some embodiments, the crop is an agricultural crop. In some variations, the agricultural crop is a flower, a tree, or a seed. In some embodiments, the crop is an agricultural crop that attracts bees.

In some embodiments, the exposing step is carried out using a vaporizer, evaporator, fan, heat, candle, or wicked apparatus.

### Methods of Identifying Repellants

In one aspect, provided herein is a method of identifying compounds that are repellent to an insect of the order Hymenoptera. In some embodiments, the method comprises: screening one or more compounds using one or more physiochemical descriptors selected from Table 3 to generate a molecular descriptor set for each of the one or more compounds; calculating a repellency score using the molecular descriptor set; and identifying compounds that are repellent to an insect of the order Hymenoptera based on the repellency score.

In certain embodiments, the repellency score may be calculated by machine learning and/or algebraic methods using the molecular descriptor set. In some variations, the molecular descriptor set is targeted to generating a bee repellency score, and the compounds identified using such bee repellency score and corresponding molecular descriptor set are structurally related to known repellents that are also predicted to be repellent. In some embodiments of the foregoing, the one or more physiochemical descriptors is selected from a physicochemical descriptor, e.g., as set forth in Table 3 below, set optimized to predict bee repellent compounds.

TABLE 3

| Name | Description |
|---|---|
| Mor28e | signal 28/weighted by Sanderson electronegativity |
| CATS2D_03_NL | CATS2D Negative-Lipophilic at lag 03 |
| Mor28s | signal 28/weighted by I-state |
| Gu | total symmetry index/unweighted |
| Eta_B | eta branching index |
| RDF040m | Radial Distribution Function - 040/weighted by mass |
| ATSC4m | Centred Broto-Moreau autocorrelation of lag 4 weighted by mass |
| RDF040v | Radial Distribution Function - 040/weighted by van der Waals volume |
| DLS_03 | modified drug-like score from Walters et al. (6 rules) |
| GATS8i | Geary autocorrelation of lag 8 weighted by ionization potential |
| DISPe | displacement value/weighted by Sanderson electronegativity |
| Mor17m | signal 17/weighted by mass |
| MAXDN | maximal electrotopological negative variation |
| TDB01e | 3D Topological distance based descriptors - lag 1 weighted by |
| | Sanderson electronegativity |
| RDF035p | Radial Distribution Function - 035/weighted by polarizability |
| GATS2s | Geary autocorrelation of lag 2 weighted by I-state |
| VE3sign_Dz(v) | logarithmic coefficient sum of the last eigenvector from Barysz matrix |
| | weighted by van der Waals volume |
| H2s | H autocorrelation of lag 2/weighted by I-state |
| E1s | 1st component accessibility directional WHIM index/weighted by I- |
| | state |
| SpDiam_AEA(dm) | spectral diameter from augmented edge adjacency mat. weighted by |
| | dipole moment |
| ATSC2s | Centred Broto-Moreau autocorrelation of lag 2 weighted by I-state |
| X5Av | average valence connectivity index of order 5 |
| Mor27s | signal 27/weighted by I-state |
| P2m | 2nd component shape directional WHIM index/weighted by mass |
| SpMax2_Bh(s) | largest eigenvalue n. 2 of Burden matrix weighted by I-state |
| P_VSA_p_2 | P_VSA-like on polarizability, bin 2 |
| IVDE | mean information content on the vertex degree equality |
| L/Bw | length-to-breadth ratio by WHIM |
| TDB03m | 3D Topological distance based descriptors - lag 3 weighted by mass |
| SM15_EA(ri) | spectral moment of order 15 from edge adjacency mat. weighted by |
| | resonance integral |
| H4p | H autocorrelation of lag 4/weighted by polarizability |
| CATS2D_04_NL | CATS2D Negative-Lipophilic at lag 04 |
| VE2sign_Dz(v) | average coefficient of the last eigenvector from Barysz matrix weighted |
| | by van der Waals volume |
| GGI1 | topological charge index of order 1 |
| Mor28m | signal 28/weighted by mass |
| RTs+ | R maximal index/weighted by I-state |
| Mor21s | signal 21/weighted by I-state |
| SpMAD_X | spectral mean absolute deviation from chi matrix |
| RDF035i | Radial Distribution Function - 035/weighted by ionization potential |
| Mor28v | signal 28/weighted by van der Waals volume |
| MATS1e | Moran autocorrelation of lag 1 weighted by Sanderson electronegativity |
| RDF010s | Radial Distribution Function - 010/weighted by I-state |
| TDB06s | 3D Topological distance based descriptors - lag 6 weighted by I-state |
| P_VSA_LogP_3 | P VSA-like on LogP, bin 3 |
| VE2sign_G/D | average coefficient of the last eigenvector from distance/distance matrix |

In some embodiments, the one or more compounds are screened computationally.

In some embodiments, the insect is a bee, wasp, or ant. In some embodiments, insect is a honeybee or other pollinators.

In certain aspects, the bee repellent compositions disclosed herein advantageously repel bees, thus allowing crop protection products to be applied during the flowering stages of crops. As described below, the bee repellent compositions may repel bees during the period that a crop protection product has residual toxicity to bees.

In one embodiment, an agricultural bee repellent composition comprises: (a) a low volatility bee repellent compound; and (b) a high volatility bee repellent compound. In one embodiment, the composition additionally comprises at least a carrier vehicle, synergist, additive, or adjuvant suitable for use in a bee repellent composition, any of which is exemplified in the present disclosure. In one embodiment, the composition additionally comprises insecticide, fungicide, herbicide, and/or seed treatment products, any of which is exemplified in the present disclosure. In some variations, the high volatility bee repellent compound immediately repels bees after application of the bee repellent composition, and the low volatility bee repellent compound provides residual repelling activity to last during the residual toxicity of a crop protection product (or products).

Volatility may be measured by Thermogravimetric Analysis (TGA) method. Volatility of bee repellent compounds is measured by TGA at 40° C. (i.e., as bee repellent wt % loss per min at 40° C.). In some variations, a “high volatility” bee repellent compound has a volatility greater than 1E-04 (wt % loss/min at 40° C.). In some variations, a “low volatility” bee repellent compound has a bee repellent volatility less than 1E-04 (wt % loss/min at 40° C.).

In some embodiments, the high volatility and low volatility compounds may be selected from any bee repelling compounds, including from ketones, amides, and anthranilates. In certain embodiments, the high volatility bee repellent compound may be selected from the following: Ethyl 2-iodobenzoate; Phenyl 3-methoxypropanoate; N,N-diethyl-meta-toluamide (DEET); 1-piperidinecarboxylic acid 2-(2-hydroxyethyl)-1-methylpropylester (Picaridin); Phenylethylanthranilate; Methyl-N-acetyl anthranilate; 4-(4-Hydroxy-2-methyl-3-quinolinyl)-2-butanone; 3-Ethyl-4-methyl-1-(2-propen-1-yl)-2(1H)-quinolinone; 4-(4-Hydroxy-2,6-dimethyl-3-quinolinyl)-2-butanone; Ethyl-2,5-dimethyl-1-[2-(methylamino)-2-oxoethyl]-1H-pyrrole-3-carboxylate; 2-chloro-5-[[(2,2-dimethyl-1-oxopropyl) amino]methyl]-N-methyl-N-(2-methyl-2-propen-1-yl)-Benzamide; 3,4-Dihydro-N-methyl-4-oxo-3-propyl-1-phthalazine carboxamide; N-3-Diethyl-3,4-dihydro-4-oxo-1-phthalazine carboxamide; 1-(4-(2-ethoxyphenyl)-1,2,3,4-tetrahydro-6-methyl-2-thioxo-5-pyrimidinyl)-ethanone; 1-(1,3-Dimethyl-1H-indol-2-yl)-1-butanone; Phenyl-3-methoxy propanoate; 2-Pentyl-2-cyclopenten-1-one; Methyl-2-ethenyl-3-pyridinecarboxylate; 1-Phenyl-3-hexanone; Hexanophenone; Valerophenone; Ethyl-2-acetyl-3-pyridinecarboxylate; rel-(1R,2R)-2-Ethoxycyclohexanol; 1-Methylindoline; 1-Phenyl-2-butanone; Indoline; 3-methyl-ethylester-benzeneacetic acid; Ethyl 2-(2,3-dihydro-1H-inden-1-yl)acetate; Ethyl m-Tolylacetate; and any mixtures thereof. In certain variations, the low volatility bee repellent compound may be selected from the following: 3-bromo-N-ethylbenzamide; 1-(2,3-Dihydro-1H-indol-1-yl)-3-ethoxy-1-propanone; N-(3-ethoxypropyl)(2-iodophenyl)carboxamide; N-Cyclohexylbenzamide; Ethyl 2-(2-Cyanoanilino) acetate; 2-Isopropoxy-1,2-diphenylethanone; and any mixtures thereof.

In some embodiments, the high volatility and low volatility compounds may be applied in any ratio to achieve the desired effect described above. In some embodiments, the ratio of low volatility bee repellent compound to high volatility bee repellent compound is from 1:99 to 99:1. In other embodiments, the ratio of low volatility bee repellent compound to high volatility bee repellent compound is from 1:75 to 75:1, from 1:50 to 50:1, from 1:25 to 25:1, from 1:15 to 15:1, from 1:12.5 to 12.5:1, from 1:10 to 10:1, from 1:5 to 5:1, or 1:1.

In some embodiments, the bee repellent composition may be formulated (with or without a crop protection product) as a suspension concentrate (SC); emulsifiable concentrate (EC); wettable powder (WP); oil-in-water emulsion (EW); suspoemulsion (SE); capsule suspension (CS); mixed formulation (ZC) containing one or more active ingredients of a CS and SC; water-dispersible granule (WG); dispersible concentrate (DC); or oil dispersion (OD).

In one embodiment, the high volatility bee repellent compound is ethyl 2-(2,3-dihydro-1H-inden-1-yl) acetate and the low volatility bee repellent compound is N-(3-ethoxypropyl)(2-iodophenyl)carboxamide or 2-Isopropoxy-1,2-diphenylethanone; the ratio of low volatility bee repellent compound to high volatility bee repellent compound is 1:1; and the composition is formulated as a suspension concentrate (SC) or an emulsifiable concentrate (EC).

In another embodiment, an agricultural bee repellent composition comprises: a slow release agricultural bee repellent formulation, comprising a coated or encapsulated bee repellent compound; and a high volatility bee repellent compound.

In some variations, the high volatility bee repellent compound immediately repels bees after application of the bee repellent composition, and the slow release bee repellent formulation provides residual repelling activity to last during the residual toxicity of a crop protection product (or products).

In some variations, the slow release agricultural bee repellent formulation may be encapsulated or coated with any encapsulation technology/coating known in the art in order to provide for slow release of the bee repellent compound such that the formulation provides residual repelling activity during the residual toxicity of a crop protection product (or products). For example, spray drying encapsulation, polyurea microencapsulation, etc. may be used to encapsulate a bee repellent compound.

In some variations, the bee repellent compound in the slow release formulation may be any bee repellent compound. For example, the bee repellent compound in the slow release formulation may be selected from ketones, amides, and anthranilates. As another example, the bee repellent compound in the slow release formulation may comprise one or more low volatility or high volatility bee repellent compounds.

In some variations, the high volatility bee repellent compound may be selected from any bee repelling compounds, including from ketones, amides, and anthranilates.

In one embodiment, the high volatility bee repellent compound may be selected from the following: Ethyl 2-iodobenzoate; Phenyl 3-methoxypropanoate; N,N-diethyl-meta-toluamide (DEET); 1-piperidinecarboxylic acid 2-(2-hydroxyethyl)-1-methylpropylester (Picaridin); Phenylethylanthranilate; Methyl-N-acetyl anthranilate; 4-(4-Hydroxy-2-methyl-3-quinolinyl)-2-butanone; 3-Ethyl-4-methyl-1-(2-propen-1-yl)-2(1H)-quinolinone; 4-(4-Hydroxy-2,6-dimethyl-3-quinolinyl)-2-butanone; Ethyl-2,5-dimethyl-1-[2-(methylamino)-2-oxoethyl]-1H-pyrrole-3-carboxylate; 2-chloro-5-[[(2,2-dimethyl-1-oxopropyl) amino]methyl]-N-methyl-N-(2-methyl-2-propen-1-yl)-Benzamide; 3,4-Dihydro-N-methyl-4-oxo-3-propyl-1-phthalazine carboxamide; N-3-Diethyl-3,4-dihydro-4-oxo-1-phthalazine carboxamide; 1-(4-(2-ethoxyphenyl)-1,2,3,4-tetrahydro-6-methyl-2-thioxo-5-pyrimidinyl)-ethanone; 1-(1,3-Dimethyl-1H-indol-2-yl)-1-butanone; Phenyl-3-methoxy propanoate; 2-Pentyl-2-cyclopenten-1-one; Methyl-2-ethenyl-3-pyridinecarboxylate; 1-Phenyl-3-hexanone; Hexanophenone; Valerophenone; Ethyl-2-acetyl-3-pyridinecarboxylate; rel-(1R,2R)-2-Ethoxycyclohexanol; 1-Methylindoline; 1-Phenyl-2-butanone; Indoline; 3-methyl-ethylester-benzeneacetic acid; Ethyl 2-(2,3-dihydro-1H-inden-1-yl)acetate; Ethyl m-Tolylacetate; and any mixtures thereof.

In a further embodiment, a slow release agricultural bee repellent composition comprises a coated or encapsulated bee repellent compound. The slow release agricultural bee repellent formulation may be encapsulated or coated with any encapsulation technology/coating known in the art in order to provide for slow release of the bee repellent compound. For example, spray drying encapsulation, polyurea microencapsulation etc. may be used to encapsulate a bee repellent compound.

In some variations, the bee repellent compound in the slow release formulation may be any bee repellent compound. For example, the bee repellent compound in the slow release formulation may be selected from ketones, amides, and anthranilates. As another example, the bee repellent compound in the slow release formulation may comprise one or more low volatility or high volatility bee repellent compounds.

In some variations, the bee repellent compositions described herein may be used in a method for repelling bees from crops. In such embodiments, a method for repelling bees from crops comprises applying a bee repellent composition described herein to a crop or a locus thereof.

In some variations, the bee repellent composition may be applied to the crop at any time, and may be applied before flowering, during flowering, just after flowering, etc.

In such methods, in addition to the bee repellent composition, one or more crop protection products (e.g., an insecticide, a fungicide, and/or a herbicide) may also be applied to the crop or locus thereof. Such crop protection product may be applied before, after, or at the same time (either in combination or separately) as the bee repellent composition.

In some variations, the bee repellent compositions described herein may also be combined with or formulated with one or more crop protection products.

In one embodiment, an agricultural bee repellent composition comprises a high volatility bee repellent compound.

### Insect Repellent System

In one aspect, provided herein is a system for repelling an insect of the order Hymenoptera, including but not limited to bees, comprising: a dispenser containing the insect repellent composition of the present disclosure, such as the bee repellent composition of the present disclosure. In some embodiments, the dispenser is a spray or a canister. Any of the odorants and other compounds disclosed herein may be used in the insect repellent compositions.

### EXAMPLES

The presently disclosed subject matter will be better understood by reference to the following Examples, which are provided as exemplary of the invention, and not by way of limitation.

### Example 1

### 1. Material and Methods

### 1.1. Predicting Repellency Using Literature and Computational Modeling

In order to identify odorants that show stronger repellency to honey bees than to other insects, we first searched the literature for promising candidates, then tested a number of compounds that were computationally predicted to have such properties based on their 3D chemical structure.

### 1.2. Testing Odorant Specificity on Fruit Flies

To find out more about the specificity of the most promising honey bee repellent candidates, we tested them using the fruit fly Drosophila melanogaster.

### 1. 2. A—Breeding Fruit Flies

We used wild-type fruit flies from our lab stock, maintained in media bottles. To synchronize the age of the flies for our experiments, we first removed all adult flies from the stock bottles. We then collected flies emerging from pupae at the desired age of 4-6 days, anesthetized them in CO2, and sorted them under a dissecting microscope into groups of 20 (10 females+10 males, each). Next, we transferred them into fresh food vials, where we left them overnight. On the following day, we transferred them into wet-starvation vials, which contained Kim-wipes soaked in distilled water. 24 hours later, we transferred the flies to the testing chambers.

### 1. 2. B—Preparing Testing Chambers and Assay for Fruit Flies

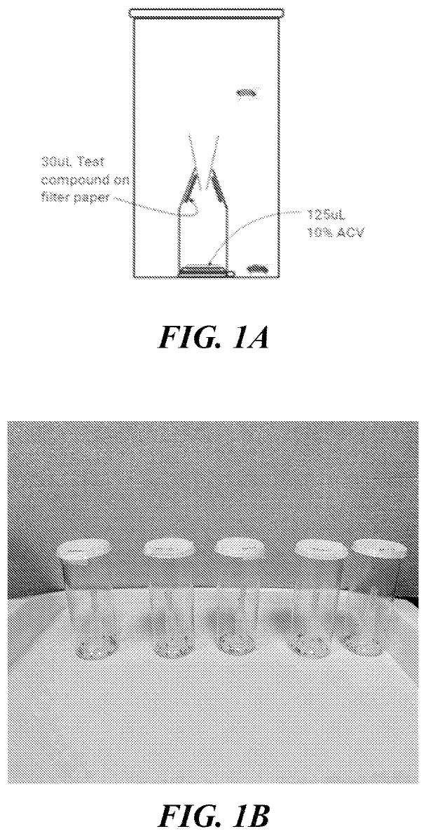

For each testing chamber (FIGS. 1A & 1B), we cut off the bottom of a 1 ml Eppendorf tube. Next, we cut two pieces of filter paper to a square. We then pipetted 30 ul of test compound at a 10% solution in paraffin oil onto the filter papers, and stuck them to the inside of the bottom of the cut-off Eppendorf tube using double-sided tape. After placing the prepared Eppendorf tube onto its lid (upside-down) into a dram-vial, we stuck a 1000-ml pipette tip into the opening of the Eppendorf tube, to create a trap-funnel. To entice the flies to participate, we pipetted 125 ul of 10% apple cider vinegar (in tap water) into the Eppendorf tube (FIGS. 1A & 1B). We left the traps on the lab bench for 18 hours at room temperature and counted the number of fruit flies that had entered the traps for each test compound.

FIGS. 1A & 1B depict Testing Chambers, each containing a 1-choice trap to determine, whether an odorant will repel male and female fruit flies (Drosophila melanogaster).

### 1. 2. B—Data Evaluation on Fruit Fly Assays

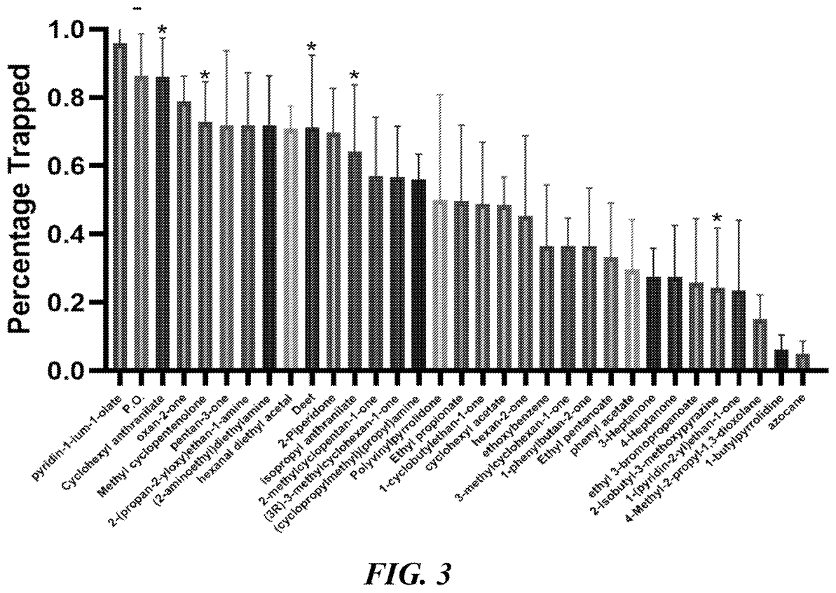

We conducted each assay five times (100 flies), except for DEET (N=6, 120 flies) and paraffin oil (N=8, 160 flies). For each compound, we summed up the number of flies caught in all the traps, then calculated the percentage of trapped flies over the total number of flies tested. We then calculated the mean and the standard errors of the mean (s.e.m.) and displayed the data graphically in FIG. 3.

### 1.3. Testing Odorant Repellency on Honey Bees

To establish, whether the computationally predicted chemicals could be used as repellents against honey bees, we tested them on workers of the honey bee Apis mellifera raised in our apiaries on campus, and aged in incubators in our lab. Between April and June 2021, we developed a new testing method as described below, and got it to work reliably.

### 1. 3. A—Raising Honey Bee Workers to Foraging Age

To date, we used capped brood frames from 10 colonies kept in three apiaries on campus at UC Riverside. After moving the brood (pupated honey bee larvae) into an observation frame inside an incubator overnight, we collected freshly emerged honey bee workers into groups of 80 per cage, providing them with a small piece of wax foundation, 50% sugar water and tap water ad libitum. Between day 3 and day 10 post emergence, we provided them with a protein dough. We removed dead workers and exchanged food every second day. After the bees reached foraging age (13-19 days post emergence), we grouped them into cages of 40 workers, each. To ensure that they were hungry enough to participate in our trials, we starved the workers before each experiment, depending on their age. Between 13 and 16 days of age, we wet-starved them for 17 hours by removing the sugar water tube from their cage, replacing it with an empty vial. Bees aged between 17 and 19 days were starved for six hours, only, to ensure their survival. On the day of the experiment, we removed dead bees and food vials from each cage, and placed the cage into a refrigerator, until the trial arena was ready, and the bees were cool enough to not move anymore.

### 1. 3. B—Preparing Testing Arenas for Honey Bees

To turn a 15 cm petri-dish into a 2-choice test arena, we taped a paper-grid on the outside of its bottom, establishing one side as honey (H) and the other as honey plus repellent candidate (HR, FIG. 3). Next, we pipetted 20 ul of pure acetone onto a 6 mm punch-out of filter paper, then let it evaporate in the fume hood for at least 30 min. We then taped the punch-out to the H-spot on the petri-dish. Repeating the process with 20 ul of the repellent candidate (5% in acetone), again letting the acetone evaporate for at least 30 Min, we stuck the now solely repellent-candidate-soaked punch-out onto the HR spot of the arena. To entice the bees to participate in our trial, we used a pipette and filled two 70 ul lids of PCR tubes full of pure, slightly warmed honey, until we observed a meniscus. We then taped one honey-filled lid onto the H, the other onto the HR filter paper, being careful not to disturb the meniscus.

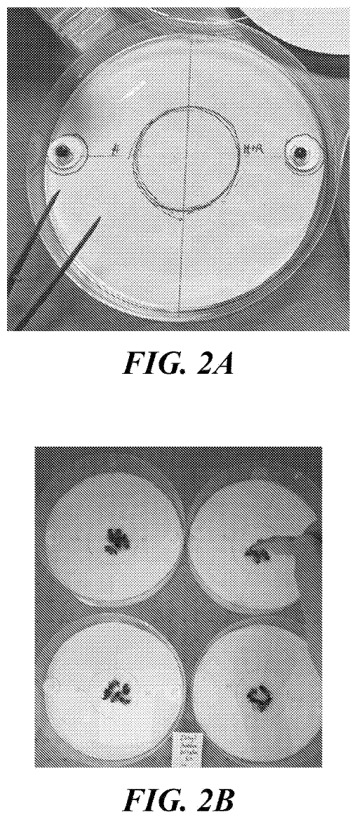

FIGS. 2A & 2B depict 2-choice petri-dish arenas used to expose bees to different repellent candidates. FIG. 2A shows an empty arena with honey wells on top of treated filter papers. FIG. 2B shows chilled bees being added to areas on top of a heating blanket at the start of the trial.

### 1. 3. C—Filming Honey Bee Trials

We placed six prepared arenas onto a heating pillow turned onto level 1 (FIG. 2B), removed the cooled honey bee workers from the fridge and grouped between four and five bees into each plate, using insect tweezers. We filmed the bees for 60 Minutes, using an ipad (video at wide-angle, 0.5). To avoid glare, we staged the ipad on top of a plexi glass pane held by a cage constructed from pvc tubes, and covered with a double cotton sheet.

### 1. 3. D—Preliminary Data Evaluation on the First Round of Honey Bee Trials

After each trial, we counted those plates, in which the honey wells had been touched as participating plates. We repeated the trials often enough to ensure participation in a minimum of five plates per repellent candidate. For each of the participating plates, we then screened each video to find the first bee that chose a honey well to drink from. The choice was recorded as either Honey (H) or Honey and repellent candidate (HR). We then calculated a Preference Index for each repellent candidate as follows: Number of repellent candidate choices minus number of honey choices) divided by sum of all choices).

### 2. Results

### 2.1. Odorant Specificity on Fruit Flies

We established that most of the odorants we tested did not repel fruit flies, as measured by the high percentage of fruit flies entering our traps (FIG. 3).

FIG. 3 depicts the mean percentage of 20 fruit flies (Drosophila melanogaster) per assay in 5 assays (100 flies) caught in a trap treated with potentially repellent odorants (10% in Paraffin oil) and baited with 10% apple cider vinegar. N=5-8 trials (˜20 floes/trial) for each. Error bars=s.e.m.* represents broad spectrum repellents with known activity. For DEET, N=8 (160 flies). For paraffin oil, N=6 (120 flies).

### 2.1. Odorant Repellency Against Honey Bees

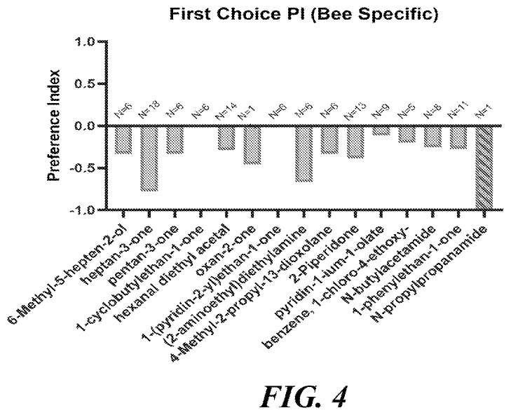

FIG. 4 shows the preference indexes for the first round of repellent candidates we tested. The negative indexes indicate, that the honey bee workers did avoid the repellent candidates, but to varying degrees. The preference indexes show the first choices of honey bee workers (Apis mellifera) offered honey on filter paper with repellent-candidates versus honey only. Groups of 4-5 honeybee workers were placed in each 2-choice arena. Indexes are calculated per repellent candidate as (total number of repellent choices minus total number of solvent choices) divided by sum of all choices).

Table 1 lists a selection of compounds with low volatility, prediction based on chemical structure from Table 2.

Table 2 lists predicted honey bee repellent compounds based on chemical structure. In Table 4, the average repellency of each compound in Table 2 is indicated on a scale of 0-1, with 1 meaning strongest repellency.

TABLE 4

| | Predicted Bee |
|---|---|
| SMILES | Repellency |
| CCCC#C | 0.964715732 |
| [H]CC([H])N1CCCC1═O | 0.961353215 |
| CC[C@@H]1CCCC1═O | 0.955149932 |
| CCN(CC)CC#C | 0.95474482 |
| CNC(C)C | 0.95441855 |
| CN1CCCC1 | 0.954005156 |
| CCOC(═O)CC(═O)CC | 0.953190987 |
| COCCC(═O)OC1═CC═CC═C1 | 0.950723737 |
| CC(C)C#C | 0.950036319 |
| CCCCCC1═CCCC1═O | 0.947505089 |
| CCC(═O)OC1═CC═CC═C1 | 0.947075421 |
| CCCCCC#C | 0.946740853 |
| CCOC(═O)CC#CC | 0.945203726 |
| COC1CCCCC1═O | 0.944469131 |
| CCOC(═O)CC | 0.942560992 |
| CCN1CCCC1 | 0.942254911 |
| CCN(CC)CCN | 0.942027916 |
| CCCC(═O)CC | 0.940876105 |
| COC(C)═O | 0.940560735 |
| CCCCC1═CC═CC═C1 | 0.939330104 |
| COC(═O)C1═CC═CN═C1C═C | 0.939080429 |
| CCCC(═O)CCC1═CC═CC═C1 | 0.936887743 |
| CCOC(═O)CCC(C)═O | 0.935933792 |
| CC(═O)OC1═CC═C(C)C═C1 | 0.93592675 |
| CCOC1CCCC1═O | 0.935009569 |
| CCCCCC(═O)C1═CC═CC═C1 | 0.934949627 |
| CCOC(═O)C1═C(N═CC═C1)C(C)═O | 0.934776302 |
| CC1CCCC1 | 0.934584157 |
| CN1CCC2═C1C═CC═C2 | 0.933603419 |
| CCOCCC(═O)N1CCC2═C1C═CC═C2 | 0.932777316 |
| CC1═C(CN)C═CC═C1 | 0.932563347 |
| CCOC(═O)C1═CC(Br)═CC═C1 | 0.932533602 |
| CCCC[C@H](C)C═O | 0.932240206 |
| CC1CCN(C)C1═O | 0.9322013 |
| CC(O)C#C | 0.931556321 |
| C#CC1CCCCC1 | 0.931256822 |
| COC(═O)C(C)═O | 0.930853998 |
| CNCCN(C)C | 0.930276573 |
| CCCCC(═O)C1═CC═CC═C1 | 0.930132762 |
| CCCCC#CC1═CC═CC═C1 | 0.93007678 |
| CCCCC(C)O | 0.92957252 |
| CCN1CCCCC1 | 0.929328907 |
| CCC(═O)CC1═CC═CC═C1 | 0.928931331 |
| CCO[C@@H]1CCCC[C@H]1O | 0.928927932 |
| CCCCC(═O)CCC | 0.927772755 |
| COCC(C)═O | 0.927258852 |
| C1CC2═C(N1)C═CC═C2 | 0.926895609 |
| CCOC(═O)CC1═C(C)C═CC═C1 | 0.926210589 |
| COC(═O)C1═C(N═CC═C1)C(C)═O | 0.926005781 |
| CCOC(═O)C1═CC(C)═CC═C1 | 0.925332152 |
| CCOC1(C)CNC1 | 0.924978137 |
| CCCC(OC)OC | 0.92479507 |
| CCCC#N | 0.924314062 |
| CCC#N | 0.923303779 |
| CCCCC(═O)CC | 0.922895183 |
| CNCC1CCCN1C | 0.922522437 |
| CCC(C)C(C)═O | 0.921981674 |
| CO[C@@H]1CCC[C@H]1N | 0.921639295 |
| CCOC(═O)C(C)═O | 0.92130442 |
| O═C(CCC1CCCC1═O)C1═CC═CC═C1 | 0.920790974 |
| CCCNC(═O)C1═C(C)C═CC═C1 | 0.920130878 |
| CCC(═O)C1═CC═CC═C1CC | 0.91997783 |
| CC(═O)OC1═CC═CC═C1 | 0.919966972 |
| CCCC(C)═O | 0.919816989 |
| COC(═O)CC(C)═O | 0.919487639 |
| ClCCN1CCCC1═O | 0.919295539 |
| COC(CC(C)═O)OC | 0.919124963 |
| COCC(═O)C1═CC═CC═C1 | 0.918216929 |
| CC1═CC═CC(CN)═C1 | 0.917839391 |
| C[C@@H]1CCCCN1 | 0.917531018 |
| C1CCC\C═C/CC1 | 0.916929093 |
| CCOC(═O)CC1CCC2═C1C═CC═C2 | 0.916053263 |
| COC(═O)C1═C(C═C)C═NC═C1 | 0.915713115 |
| CCOC(═O)C(CC)C#N | 0.91529278 |
| CCCNCCC | 0.915291282 |
| CCOC(═O)C1═C(C)C═CC═C1 | 0.914979335 |
| CO[C@@H]1CCCC[C@H]1N | 0.914773344 |
| CCNC(═O)C1═C(C═O)C═CC═C1 | 0.914733289 |
| CCCC═C | 0.914559586 |
| CCN(CC)CC#CC | 0.914553455 |
| C#CCC1═CC═CC═C1 | 0.914423804 |
| CCC1═C(O)C═CC═C1 | 0.914309222 |
| CCCCCN | 0.914238985 |
| CCCCC(═O)C(C)C | 0.913628895 |
| C(N1CC1)C1═CC═CC═C1 | 0.913322967 |
| CCC(CC)CN | 0.912986708 |
| CCOCCC(═O)N(CC)C1═CC═CC═C1 | 0.912536583 |
| CCOC(═O)\C═C\C | 0.912265739 |
| CCCCCCCC#C | 0.912095687 |
| C[C@H]1CCC[C@H]1O | 0.911925406 |
| CO[C@@H]1CCCCC[C@H]1N | 0.91185628 |
| COC(═O)C1═CC═CN═C1C | 0.911817648 |
| CCOC(═O)C1═CC═CC2═C1CNCC2 | 0.911728239 |
| CNOC1CCCC1 | 0.911389097 |
| CC(═O)OCCC1═CC(Br)═CC═C1 | 0.911310794 |
| CCC#CC1CCCCC1 | 0.910942717 |
| CCCCNC | 0.910838705 |
| CCOC(═O)C1═CC(C)═NC2═CC═CC═C12 | 0.910653364 |
| CCOC(═O)C1═CC2═C(CCO2)C(OC)═C1 | 0.909117993 |
| CN(C)CCC1═CC═CC═C1 | 0.909068474 |
| CCOC(═O)C1═CC═CC2═NC═CC═C12 | 0.908928787 |
| CN1CCC(C1)OC(═O)C1═CC═CC═C1 | 0.908747754 |
| C#CCN1CCCCC1 | 0.908304017 |
| CC1═NCCCC1 | 0.907966852 |
| CCCCN1CCCC1 | 0.907650151 |
| NC[C@H]1CCCO1 | 0.907116552 |
| CCOCCC(OCC)OCC | 0.907060634 |
| CC[C@@H]1CCC[C@H]1N | 0.906990543 |
| NCCC1═C(C═CC═C1)C#C | 0.906983066 |
| CO[C@@H]1CCCC[C@H]1O | 0.906885934 |
| CCCCCCC(═O)CC | 0.906758139 |
| O═C(NCC1═CC═CC═C1)N1CCCC1 | 0.906500569 |
| CC[C@@H]1CCCN1 | 0.906420158 |
| CCC1═C(C═CC═N1)C(═O)OC | 0.906303633 |
| C[C@H]1CCCCN1 | 0.905844422 |
| CN(C)CC1═CC═CC═C1 | 0.905806424 |
| CCC(═O)C1═CC(Br)═CC═C1 | 0.905445641 |
| CCCCOCCCC | 0.905424649 |
| CCCCCC1═CC═CC═C1 | 0.905112377 |
| CCOC(═O)CCC1═CC═CC═C1CN | 0.904724013 |
| CCCNCC | 0.904713375 |
| COC(═O)CCC(═O)C1═CC═CC═C1OC | 0.904622157 |
| CC(═O)OC1═CC═C(CC1)C═C1 | 0.904106625 |
| CCCCCCC═C | 0.90389951 |
| CCCNC1═CC═CC═C1 | 0.903783952 |
| CCC(C)═O | 0.903370606 |
| O═C1CCCC2═CC═CC═C12 | 0.90335456 |
| CCOC(═O)CC1CCNC2═C1C═CC═C2 | 0.903236231 |
| O═C═NCCC1═CC═CC═C1 | 0.903234918 |
| NCC1CC1 | 0.90239789 |
| CCNCCN(C)C | 0.902303872 |
| O[C@@H]1CCSC1 | 0.902228688 |
| CCOC(═O)CC(C)═CC#N | 0.902080219 |
| CCCCOC(═O)C1═C(C)C═NC2═CC═CC═C12 | 0.901939735 |
| CN(C)CCC(═O)C1═CC═CN═C1 | 0.901741268 |
| CN1C[C@H]1C1═CC═CC═C1 | 0.901378771 |
| CN1C[C@@H]1C1═CC═CC═C1 | 0.9013613 |
| CN(C)CCC(═O)C1═CC═CC═C1 | 0.900902126 |
| CO[C@@H]1CC[C@@H]2CNC[C@H]12 | 0.900055938 |
| C#CCOCC1═CC═CC═C1 | 0.899945029 |
| CCOC(═O)CC1═CC═CN═C1 | 0.899649099 |
| BrC1═C(CCCC═C)C═CC═C1 | 0.899642872 |
| CC1CCCCN1 | 0.899574186 |
| CCOC(═O)CC1═C(Br)C═CC═C1 | 0.899540179 |
| CCCCOC(═O)C1═CC═CC═C1 | 0.899384223 |
| CCC(O)C#C | 0.899278055 |
| CCCCC(═O)CC1═CC═CC═C1 | 0.899041697 |
| CCOC(═O)C1═CC═CC2═C1CCN2 | 0.898755217 |
| C1CCCC1 | 0.898339266 |
| CCOC(═O)C1CC1 | 0.898155192 |
| CC1N(C)CCC1═O | 0.897989332 |
| CC1CC1NC1═CC═CC═C1 | 0.897947241 |
| CCOC(═O)CC1═CCC2═C1C═CC═C2 | 0.897780435 |
| CCCCCC#N | 0.897678488 |
| COC1═C(Br)C═C(OC(C)═O)C═C1 | 0.897393211 |
| CCOCCOC(═O)C1═CC═CC═C1 | 0.897185226 |
| CC(═O)CC(═O)OCC═C | 0.895912747 |
| COC(═O)C1═C(C═O)C═C(Br)C═C1 | 0.895889223 |
| CC(C)OC1═C(OCCN(C)C)C═CC═C1 | 0.895861582 |
| CC1═NCCC2═CC═CC═C12 | 0.895318324 |
| CC(═O)OC(C)═C1C═CC═C1 | 0.895159079 |
| COC(═O)\C═C\C | 0.894990382 |
| CCOC(═O)C(Br)CC | 0.894556065 |
| CCOCC(═O)N1CCCC2═C1C═CC═C2 | 0.894485032 |
| CCSCCOC(═O)C1═CC═CC═C1C#N | 0.894413826 |
| CC1CC2═C(O1)C═CC═C2 | 0.894211073 |
| CCOC1═CC═CC═C1C(═O)O[C@H]1CCOC1 | 0.893408581 |
| CCOC(═O)C1═CC═CC2═CC═CC═C12 | 0.893382695 |
| CN[C@@H]1CCCN(C)C1 | 0.893362839 |
| CCOCC(═O)CC(C)═O | 0.893323589 |
| C(C1CO1)C1═CC═CC═C1 | 0.893265799 |
| CCCCC(═O)NC1═C(CC)C═CC═C1 | 0.893186401 |
| CCNC(═O)C1═CC(Br)═CC═C1 | 0.893128081 |
| O═C(N1CCCC1)C1═CN═CC═C1 | 0.89288428 |
| CCOC(CC1═CC═CN═C1)OCC | 0.892839446 |
| CCCCC(═O)OC1═CC═CC═C1CC | 0.892627484 |
| C[14C]1═[14CH][14CH]═[14CH][14CH]═[14CH]1 | 0.892563689 |
| CC(═O)C1═CC═CC═C1C | 0.892493619 |
| CCC(═O)C(C)S | 0.892463654 |
| NCCN1CCCCC1 | 0.892433954 |
| FC1═CC═CC═C1CCC(═O)N1CCCC1 | 0.892418347 |
| CCCCC(═O)NC1═C(C)C═CC═C1CC | 0.892235243 |
| CCC(═O)CCC1═CC═CC═C1 | 0.892116203 |
| C1CCCCC1 | 0.892026236 |
| CC1═C(CC#N)C═CC═C1 | 0.891992813 |
| CCCC(═O)C1═CC(C)═CC═C1 | 0.891962838 |
| CCOC(═O)C1CC1C | 0.891685922 |
| CCOC(═O)[C@@H]1C[C@H]1C | 0.891659698 |
| CCOC(═O)C═CCCl | 0.891643969 |
| CCOC(═O)C1═CC═CN═C1CCl | 0.891546108 |
| CCC1═CC═C(C)C═C1 | 0.891055771 |
| BrCCCCCCOC1═CC═CC═C1 | 0.890693965 |
| CCC(CC)CCO | 0.890676534 |
| CCC(═O)C1═CC(C)═CC═C1 | 0.890249809 |
| CCOCC(C)C | 0.890199129 |
| CCNC1═CC═C(C)C═C1C(═O)OCC | 0.890049285 |
| CC(C)OCC1═CC═CC═C1 | 0.890044298 |
| CCOCCCNC(═O)C1═CC(C)═CC═C1 | 0.889549493 |
| CCC\C═C\CC | 0.889003858 |
| CN[C@@H]1CCCC[C@H]1N | 0.888808326 |
| C1CC2═C(C1)C═CC═C2 | 0.888688686 |
| CN1NC2═CC═CC═C2C1═O | 0.888637442 |
| CSCCC(═O)N1CCC2═CC═CC═C12 | 0.888575823 |
| CCOC(═O)CCC1═CC═CC═C1 | 0.88840984 |
| CCCOC(═O)C1═CC═CC═C1 | 0.88829132 |
| CN1CCC(CC1)NC(═O)C1═CC═CC═C1 | 0.888168126 |
| CCOC(CC1═CC(Br)═CC═C1)OCC | 0.887730425 |
| CC(═O)OC1═CC═CC(═C1)C(C)═O | 0.886704302 |
| C[C@H]1OCC[C@H]1CO | 0.886447446 |
| CCCCCCC#C | 0.8864189 |
| CCCCCCCCC═C | 0.886374602 |
| CC#CC1CCCCC1 | 0.886297838 |
| COC(═O)C1═C(C═CC═C1)C(C)═O | 0.886064103 |
| CC1═C(C═CC═C1)C(═O)NCC═C | 0.885894548 |
| SCCCCOC1═C(Br)C═CC═C1 | 0.885776043 |
| CCOC(═O)C1═C(C)N═CC═C1 | 0.885491033 |
| CCOC1═C(CC#N)C═CC═C1 | 0.885347933 |
| C#CCCC1═CC═CC═C1 | 0.885066264 |
| CCOCC1═CC═CC═C1 | 0.884958091 |
| CCOC(═O)CC1═CC═CC═C1 | 0.884788631 |
| CCOC(═O)C1═NNC2═CC═CC(OC)═C12 | 0.88458847 |
| CCOC(═O)C1═CC═C(C)C═C1Br | 0.88430469 |
| OCC1CCC1═O | 0.884079168 |
| CN1CCCNCC1 | 0.883807201 |
| CC(═O)OC1═CNC2═CC═CC═C12 | 0.883690274 |
| CCOCCCNC(═O)CC1═CC═CC═C1C | 0.88332066 |
| CCC1═C(OC)C═CC═C1 | 0.883309917 |
| CCC1═CC═CC═C1CC#N | 0.883303112 |
| CC(═O)CCC1═CC═CC═C1 | 0.883171648 |
| COC(═O)CC1═CC(CCl)═CC═C1 | 0.883163042 |
| NCCCCN1CCCC1 | 0.883143107 |
| NC1CCC1 | 0.882899848 |
| ClCCCCCOC(═O)C1═CC═CC═C1 | 0.882526509 |
| NCCN1CCCC1 | 0.882223849 |
| COC(═O)C(C)C(C)═O | 0.881838629 |
| NCCC1CCCC1 | 0.881491599 |
| C[C@@H]1CC2═C(N1)C═CC═C2 | 0.881023642 |
| CCOC(═O)C(═O)C1═CC═CC═C1 | 0.880941253 |
| C[C@H]1CC2═C(N1)C═CC═C2 | 0.880909487 |
| COC1CCCC(═O)CC1 | 0.880838387 |
| CCOCCCNC(═O)C1═C(I)C═CC═C1 | 0.880680934 |
| CSCCC(═O)OC1═CC═CC═C1 | 0.880256 |
| CCCCCCN | 0.880185675 |
| CCC1═CC═C(C═C1)C(═O)C1═CC═CC═C1 | 0.880119974 |
| COC(OC)C1═CC═CC═C1 | 0.879907478 |
| CNC1═NC2═CC═CC═C2C(═C1)C(═O)OC | 0.879874396 |
| CCOC(═O)COC1═C(Br)C═CC═C1 | 0.879695324 |
| CCOC(═O)CC1═CC═NC═C1 | 0.879631819 |
| CCOC(C)(C)CC | 0.879146936 |
| CC(═O)C1═CNC═C1C | 0.878705586 |
| CCCC(═O)NC1═C(C═CC═C1)C1═CC═CC═C1 | 0.878499735 |
| BrC1═CC═CC(═C1)C(═O)CCC#N | 0.878434134 |
| CCN(CC)CC#N | 0.878420437 |
| CCN(CC)CC(C)═O | 0.878389537 |
| CCC(═O)NC1═CC(C)═CC═C1 | 0.878270237 |
| CN1CCCN═C(C2═CC═CC═C2)C1═O | 0.878165094 |
| CCCCN | 0.877903173 |
| CCOC═C1C(═O)C2═CC═CC═C2C1═O | 0.877754527 |
| CC(C)OCCCC#C | 0.877705572 |
| CN1CCCC(N)C1 | 0.877504507 |
| CC(═O)OC1═C2C═CNC2═CC═C1 | 0.87746771 |
| CCOC(═O)C1═C(C═CC═C1)C(C)═O | 0.877457584 |
| CN(CC#C)CC1═CC═CC═C1 | 0.877306187 |
| COC(C)[C@H](C)CN | 0.877083626 |
| CCOC(OCC)OC1═CC═CC═C1 | 0.877078735 |
| CCN(CC)C(═O)C1═CC═CC═C1 | 0.877076269 |
| CCN(CC)CCNC | 0.876913222 |
| CCCC(═O)C1═CC═CC═C1 | 0.876842341 |
| CC(═O)C1═CC═CC═C1\C═C\C1═CC═CC═C1 | 0.876819582 |
| CCCCC(═O)C1═CC═C(C)C═C1 | 0.876777454 |
| CCOCCCNC(═O)C1═CC═CC═C1 | 0.876730224 |
| CCCCN1NC2═CC═CC═C2C1═O | 0.876492521 |
| CCCCNC(═O)C1═CC(C)═C(C)C═C1 | 0.876289615 |
| CCC1═C(C)C═CC(C)═C1 | 0.876115528 |
| CC(═O)OC1═CC═CC═C1F | 0.876088634 |
| CN(C)CCCN | 0.876059902 |
| CCOC1═C(OCC#CCNC)C═CC═C1 | 0.87604543 |
| CCOC(═O)C1═C(I)C═CC═C1 | 0.875885474 |
| CCCN1CCC[C@H]1CN | 0.875859214 |
| CO[C@@H]1COC[C@H]1O | 0.875743652 |
| O═C(OCCC#N)C1═CC═CC═C1 | 0.875683884 |
| COC(C)[C@@H](C)CN | 0.875675794 |
| CO[C@@H]1CNCC[C@H]1C | 0.875538069 |
| CCCNC(═O)C1═CC(Br)═CC═C1 | 0.87553196 |
| CCOC1═C(C═CC═C1)C(Cl)═O | 0.875316377 |
| CCNCCOC1═C(OCC2═CC═CC═C2)C═CC═C1 | 0.875209524 |
| NC[C@@H]1CCCO1 | 0.875193474 |
| CCOC(═O)C1═C(OC═N1)C1═CC═CC═C1 | 0.875114117 |
| CCCCC | 0.875088069 |
| CCO\C═C1/C(═O)N(CC)C2═C1C═CC═C2 | 0.87489654 |
| CCCCCC1═NC═CC═C1 | 0.874886883 |
| CCCCCCC(═O)CCC | 0.874834273 |
| COC1CNCCC1C | 0.874806581 |
| CCCCC(C)═O | 0.874725068 |
| COC(═O)C1═CC═CO1 | 0.87449512 |
| CCOCC1═CC═C(C)C═C1 | 0.874107988 |
| NC[C@H]1CCNC1 | 0.873661563 |
| BrC1CCCCCC1 | 0.873649376 |
| CCOC(CO)C1CC1 | 0.873555247 |
| COC(═O)C1═C(OC═C1)C═O | 0.873392096 |

### Example 2

Table 5 depicts the structures, physical properties and repellency ofthe compounds in the tables. Preference Indexes for repellent candidates were determined in a manner similar to that described in Example 1. Table 5 lists the preference index of honeybees in making the first choice to move to the repellent treated side in a 2-choice plate assay (N=number ofplates). The first choice preference index=the number ofhoneybees that first visit and drink honey placed over the (repellent treated filter paper—solvent treated filter paper)/(repellent treated filter paper+solvent treated filter paper). In other words, indexes are calculated per repellent candidate as (total number ofrepellent choices minus total number of solvent choices) divided by sum of all choices). Table 5 also lists the preference index ofhoneybees consuming honey from the repellent treated side a 2-choice plate assay (N=6-18 plates). The honey consumption (drinking) preference index=plates where honeybees drank more honey from (repellent treated filter paper—solvent treated filter paper)/(repellent treated filter paper+solvent treated filter paper).

TABLE 5

| | | | | Honey | First | | | |
|---|---|---|---|---|---|---|---|---|
| | | | | con- | choice | | | |
| | | | | sumption | Pref- | | | |
| | | | | Preference | erence | % honey | | |
| | | Predicted | | Index | Index | left on | | |
| | Chemical | vapor | | (repellent | (repellent | repellent | | Physical |
| ID | name | pressure | Structure | side) | side) | side | N | state |
| BR 3.15 | ethyl o-tolylacetate | 0.0326 | 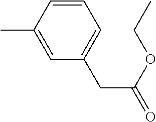 | −1 | −1 | 99.44 | 12 | liquid |
| BR 3.47 | 3-bromo- N- ethylbenzamide | 0.000147 | 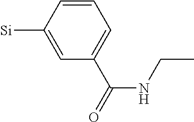 | −0.6666 | −1 | 95.42 | 6 | solid |
| BR 3.30 | N-(3- ethoxypropyl)(2- iodophenyl) carboxamide | 0.00000331 | 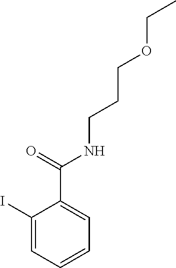 [SMILES: CCOCCCNC(=O)c1ccccc1I] | −0.8 | −0.733 | 80.45 | 15 | solid |
| BR 3.81 | Ethyl 2- iodobenzoate | 0.00185 | 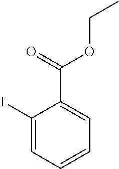 | −0.9 | −0.9 | 99.17 | 20 | liquid |
| BR 3.3A | ethyl 2- (2,3- dihydro- 1H-inden- 1- yl)acetate | 0.00223 | 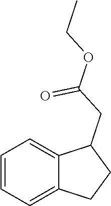 | −1 | −1 | 95.83 | 14 | liquid |
| BR 3.5 | Hexanophenone | 0.0094 | 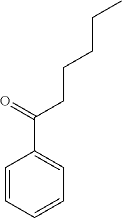 | −1 | −1 | 100 | 9 | liquid |
| BR 3.1 | Phenyl 3- methoxy- propanoate | 0.00954 | 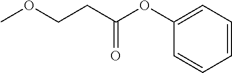 | −0.9166 | −0.8333 | 99.17 | 24 | liquid |
| BR 3.4 | 1-Phenyl-3- hexanone | 0.0106 | 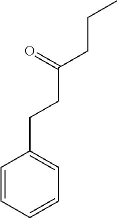 | −1 | −1 | 99.72 | 12 | liquid |
| BR 3.42 | (2E)-1,3- Diphenyl- 2-buten-1- on | 0.0 ± 0.7 | 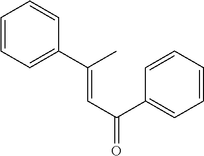 [SMILES: C/C(=C\C(=O)c1ccccc1)c1ccccc1] | −0.727 | −0.772 | | 22 | liquid |
| BR 3.9 | 1-(2,3- Dihydro- 1H-indol- 1-yl)-3- ethoxy-1- propanone | 0.000033 | 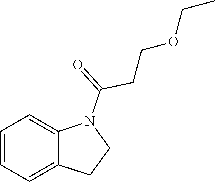 [SMILES: CCOCCC(=O)N1CCc2ccccc21] | −0.8 | −0.6 | | 10 | |
| BR 4.4 | 3-(3- Pyridinyl)- 1-(4- pyridinyl)- 2-propen- 1-one | 2.52E-005 | 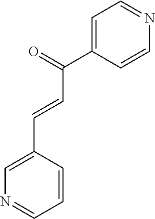 [SMILES: O=C(/C=C/c1cccnc1)c1ccncc1] | −0.71428 | −0.7142 | | 14 | Solid |
| BR 4.5 | 2-Isopropox y-1,2- diphenyl- ethanone | 2.75E-005 | 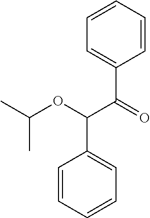 [SMILES: CC(C)OC(C(=O)c1ccccc1)c1ccccc1] | −0.8947 | −0.8947 | | 19 | Solid |

### Honeybee Robbing Assay

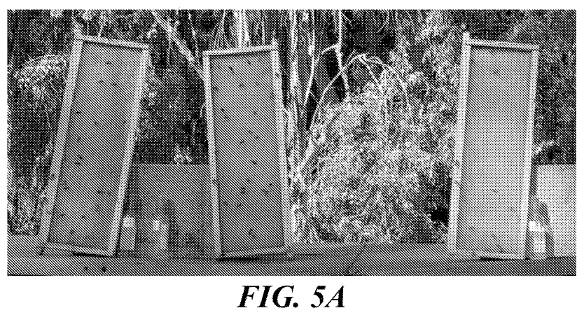

FIG. 5A depicts a photograph of a honey bee robbing assay with honeycombs sprayed with equal amount of 50% sugar water solution and a 5% solution in acetone of DEET (left frame) and BR3.15 (right frame), with control acetone solvent spray frame in the center. The counts of numbers of bees on each frame from videos of the assay are represented as a graph in FIG. 5B. Mean counts from 5 minute interval snapshots, over a period of 30 minutes, that is 6 trials for each repellent or solvent (Acetone, DEET, BR3.30 (N-(3-ethoxypropyl)(2-iodophenyl)carboxamide), BR3.15 (ethyl o-tolylacetate), and BR3.3A (ethyl 2-(2,3-dihydro-1H-inden-1-yl)acetate)), are depicted.

### Example 3

A TA Instruments TGA5500 was used to determine the volatility of bee repellent chemicals at 40 degrees Celsius. The sample purge was set for 25 mL/min and the balance purge is set for 10 mL/min. A 30 mg sample of the chemical was placed in the sample pan, the temperature was ramped up to 40° C. at a rate of 10° C./min and was held isothermal at 40° C. for 900 minutes. The slope was then determined from 800-900 minutes to determine its volatility. The volatility of bee repellent compounds were determined according to Table 6 below.

TABLE 6

| | TGA volatility @ 40° C. |
|---|---|
| Bee Repellent Compound | (weight loss %/min) |
| 2-Decanone | 0.1623 |
| Ethyl m-Tolylacetate | 2.73E−02 |
| Phenyl 3-methoxypropanoate | 1.66E−02 |
| 1-phenyl-3-hexanone | 1.37E−02 |
| Hexanophenone | 1.11E−02 |
| Ethyl 2-iodobenzoate | 6.66E−03 |
| ethyl 2-(2,3-dihydro-1H-inden-1-yl) acetate | 4.61E−03 |
| DEET | 2.29E−03 |
| 3-bromo-N-ethylbenzamide | 1.40E−04 |
| Ethyl 2-(2-Cyanoanilino) acetate | 4.04E−05 |
| N-(3-ethoxypropyl)-2-iodobenzamide | 2.16E−05 |

### Example 4

### Comparative Assessment of Various Bee Repellent Formulations

Two BR3.3A (liquid) and BR 4.5 (solid) bee repellents were used in this example for comparison. BR 3.3A has a relatively higher volatility compared to BR 4.5. A TGA method was developed to characterize volatility of bee repellents. The volatility was measured by setting up a TGA method. In the TGA pan, 0.30 mg+0.02 mg of the bee repellent of interest is applied in an even layer on the bottom of the TGA pan immediately before starting the measurement. The TGA is programmed to have a balance purge flow of 40 mL/min and a sample purge flow of 60 mL/min. The TGA ramps from 25° C. to 40° C. at a rate of 5° C. per minute. Then the temperature is held isothermally at 40° C. for 15 hours. After the test has been completed, the slope is calculated for the % loss per minute between 800-900 minutes and the results are reported. The smaller the slope, the less the volatility. The volatility of BR3.3A measured by the above method has a slope of −4.61E-03%/min, and the slope for BR4.5 is −1.81E-04%/min.

Three different solo or mixture formulations as summarized in the tables below were assessed for bee repellency in small tunnel setup.

TABLE 7
Formulations tested

| Formulation | | | BR physical | |
|---|---|---|---|---|
| ID | Type | BR* (%) | state | Solo/mixture |
| BAS 642 AA S | EW | 10% BR 3.3A | Liquid | Solo formulation |
| BAS 644 AA S | SC | 10% BR 4.5 | Solid | Solo formulation |
| BAS 645 AA S | SE | 5% BR 3.3A + | Solid + | Mixed |
| | | 5% BR 4.5 | liquid | formulation |

*BR: Bee Repellent compound

Formulation according to the tables below were prepared.

TABLE 8
BAS 642 AA S - 10% EW Formulation

| Ingredient | Function | Aim % |
|---|---|---|
| BR 3.3A | Active Ingredient | 10.0% |
| Atlas G-5000 | Dispersant | 2.0% |
| Morwet D-425 | Dispersant | 3.0% |
| Xanthan Gum | Thickener | 0.3% |
| Acticide B 20 | Preservative | 0.02% |
| Wacker Silicon SRE-PFL | Antifoam | 0.1% |
| Water | Filler | Add to 100% |

BAS 642 AA S—10% EW was prepared by making an aqueous phase that includes partial amount water, Wacker Silicon SRE-PFL, Morwet D425, and Atlas G-5000. The BR 3.3A was mixed in under high shear using a homogenizer and mixed until the aim particle size for the oil droplets was achieved. Next, the Xanthan Gum was prepared into a thickener solution by hydrating it into the remaining water and Acticide B20. Once the Xanthan Gum was fully hydrated, it was mixed into the BR 3.3A oil emulsion and mixed until homogenous.

TABLE 9
BAS 644 AA S - 10% SC Formulation

| Ingredient | Function | Aim % |
|---|---|---|
| BR 4.5 | Active Ingredient | 10.0% |
| Atlas G-5000 | Dispersant | 2.0% |
| Morwet D-425 | Dispersant | 3.0% |
| Xanthan Gum | Thickener | 0.3% |
| Acticide B 20 | Preservative | 0.02% |
| Wacker Silicon SRE-PFL | Antifoam | 0.1% |
| Water | Filler | Add to 100% |

BAS 644 AA S—10% SC formulation was prepared by first making a millbase of BR 4.5. This is done by mixing partial amount of the water, Wacker Silicon SRE-PFL, Morwet D425, and Atlas G-5000 together until homogenous. Then BR 4.5 was added to the mixture and homogenized until uniformed. Then the sample was bead milled until the aim particle size of the BR 4.5 solid was achieved. Next, the Xanthan Gum was prepared into a thickener solution by hydrating it into the remaining water and Acticide B20. Once the Xanthan Gum was fully hydrated, it was mixed into the BR 4.5 millbase and mixed until homogenous.

TABLE 10
BAS 645 AA S - 10% SE Formulation

| Ingredient | Function | Aim % |
|---|---|---|
| BR 3.3A | Active Ingredient | 5.0% |
| BR 4.5 | Active Ingredient | 5.0% |
| Atlas G-5000 | Dispersant | 2.0% |
| Morwet D-425 | Dispersant | 3.0% |
| Xanthan Gum | Thickener | 0.3% |
| Acticide B 20 | Preservative | 0.02% |
| Wacker Silicon SRE-PFL | Antifoam | 0.1% |
| Water | Filler | Add to 100% |

To prepare BAS 645 AA S—10% SE formulation first a sample of BAS 642 AA S—10% BR 3.3A EW was prepared using the method described above. Then, a sample of BAS 644 AA S—10% BR 4.5 SC was prepared using the method described above. Lastly, the two formulations were mixed in a 1:1 ratio until homogenous.

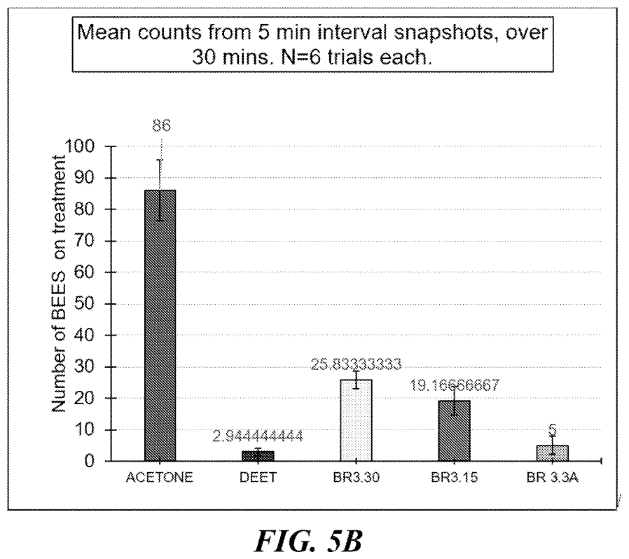

The basic test design was as follows: Bee tunnel of 22 m length and 6.5 m width was used. 1 honey bee hive of medium strength was placed in the tunnel. Four 48-well plates on a 33×33 cm cardboard were used as a sugar feeding station for bees in the tunnel. A fixed amount of sugar solution was added to 48-well plates. Bees were trained on sugar feeding station for 2-3 days initially and then 10 minutes on the test day before replacing with control or treated feeding plates. Cardboard with sugar plates was sprayed with the test item under spray booth and immediately transferred to the tunnels after application (<1 min). Battery-powered balances and cameras were used for weight and forager activity readings. Whole sugar station was directly placed on the measuring scale for continuous recording. See FIG. 6.

Each formulation was tested at the rate of 5% BR concentration with a spray-volume of 100 L/ha (˜10 kg a.i./ha) at 3 different times of day: 8:00; 10:00 and 12:00 o'clock. The feeding plates (with cardboard) were switched after 10 min for each run in the following sequence: Attraction Plates>Control Plates>Test item Plates>Control Plates

Data collection: readings on weight of sugar solution consumed and forager counts (photo documentation) were taken every minute for 10-minute observation period

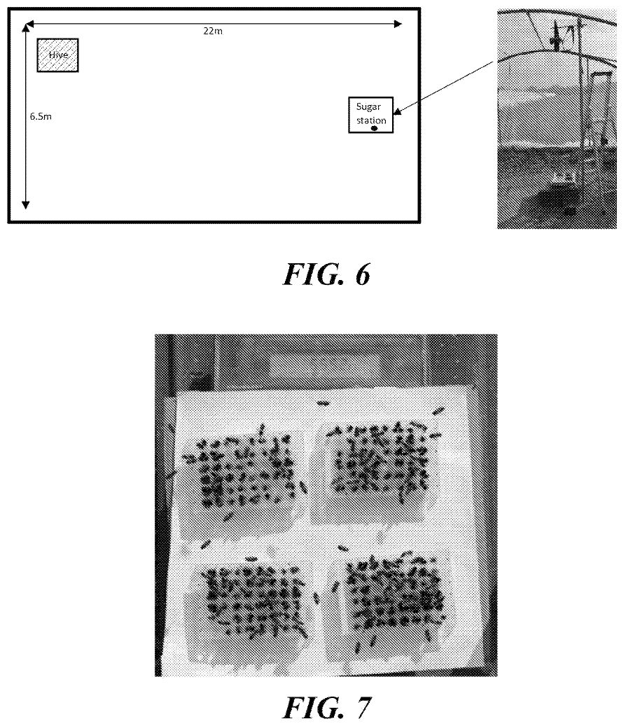

The control plates (sugar solution only) were run before and after each test item in order to minimize any effect of time on bee activity. The weight of sugar solution consumed over 10-minute observation period in test plates was compared with the average of two controls. See FIG. 7.

### Results

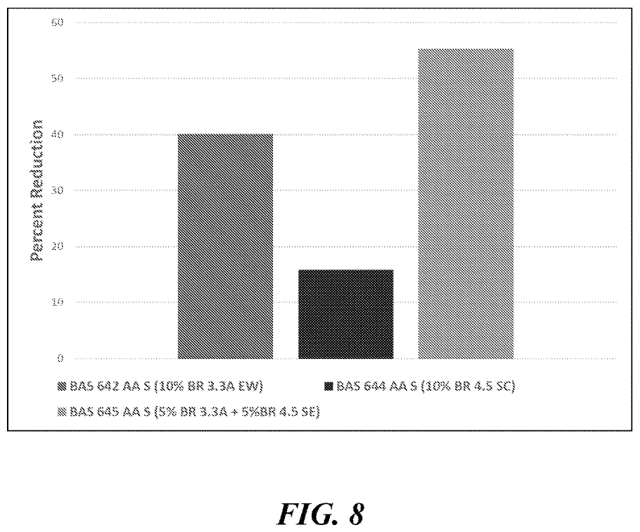

All three samples with bee repellents show clearly less food consumption compared to control without (bee repellent). However, the food consumption data shows that the mixed formulations included a liquid bee repellent (higher volatility) together with a solid bee repellent (low volatility) show less food consumption than the solo formulations individually at the same use rate, indicating the mixture formulation included a low volatility bee repellent and a high volatility bee repellent have a stronger repellent effect compared to single bee repellents individually. See Table 11 and FIG. 8.

TABLE 11
Effect of different bee repellent formulations
on sugar solution consumption

| | | Consumption | Consumption | | Mean |
|---|---|---|---|---|---|
| | Test | in control | in test | Reduc- | Reduc- |
| Formulation | time | plates (g) | plates (g) | tion (%) | tion (%) |
| BAS 642 | 8:00 am | 146.26 | 74.78 | 48.87 | 40.07 |
| AA S | 10:00 am | 157.85 | 89.12 | 43.54 | |
| | 12:00 pm | 139.88 | 101.01 | 27.79 | |
| BAS 644 | 8:00 am | 177.32 | 126.86 | 28.46 | 15.89 |
| AA S | 10:00 am | 177.44 | 152.83 | 13.87 | |
| | 12:00 pm | 190.48 | 180.28 | 5.35 | |
| BAS 645 | 8:00 am | 129.69 | 51.07 | 60.62 | 55.31 |
| AA S | 10:00 am | 133.48 | 51.13 | 61.69 | |
| | 12:00 pm | 175.66 | 99.06 | 43.61 | |

### Example 5

### Field Study of BR3.81 and DEET

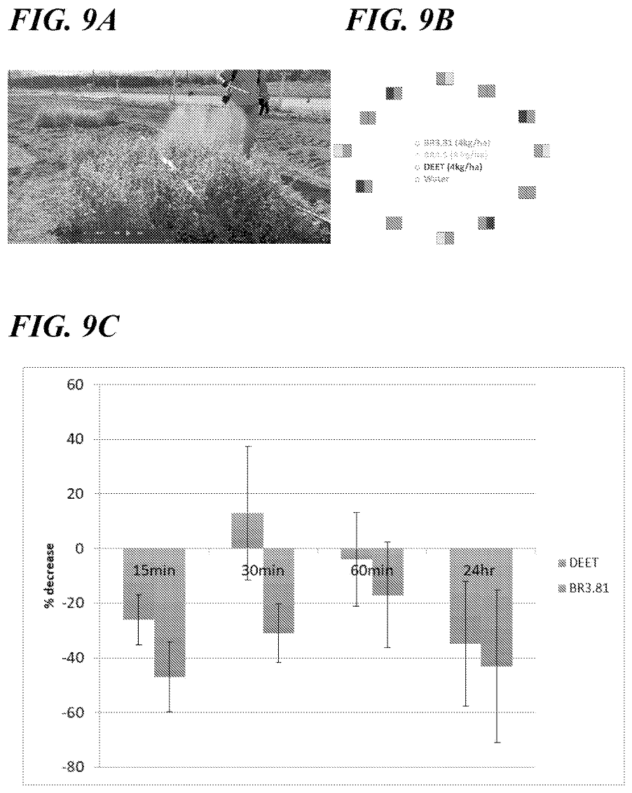

In this field study, 12 patches of buckwheat were planted, each measuring approximately 2 m×2 m in size in the agricultural operations field. When the flowering was estimated to be >50%, the experiments were performed. Each patch was divided into 2 approximately equal parts based on flowers by observation, one side for treatment spray and the other as control solvent (water) spray (FIG. 9A). The patches for different treatments were in a block design and the treatment side in a patch was randomly assigned as water or treatment (FIG. 9B). The test chemicals in emulsifiable concentrate form were dissolved in water in a tank to spray at the rate equivalent to 4 kg/hectare. After the spraying the numbers of honey bees present on each side of each patch was counted by 3 human observers at the following time points: 15 min, 30 min, 1 hour, 24 hours. The average number of bees at each time point were used to calculate the percentage decrease in numbers of bees on the treatment side relative to the water side and plotted (FIG. 9C).

The details of the BR3.81 and DEET formulations used in this study are provided below.

BR 3.81 Formulation:

| Ingredient | Function | Concentration (%) |
|---|---|---|
| BR 3.81 | Active Ingredient | 90% |
| Wettol EM 1 | Emulsifier | 3% |
| Wettol EM 31 | Emulsifier | 7% |

To prepare BR 3.81 formulation, the Wettol EM 1 and Wettol EM 31 were mixed into the BR 3.81 liquid until the sample was homogenous.

DEET Formulation:

| Ingredient | Function | Concentration (%) |
|---|---|---|
| DEET | Active Ingredient | 90% |
| Wettol EM 1 | Emulsifier | 3% |
| Wettol EM 31 | Emulsifier | 7% |

To prepare the DEET formulation, the Wettol EM 1 and Wettol EM 31 were mixed into the DEET liquid until the sample was homogenous.

BR 4.5 Formulation

| Ingredient | Function | Concentration % |
|---|---|---|
| BR 4.5 | Active Ingredient | 10.0% |
| Atlas G-5000 | Dispersant | 2.0% |
| Morwet D-425 | Dispersant | 3.0% |
| Xanthan Gum | Thickener | 0.3% |
| Acticide B 20 | Preservative | 0.02% |
| Wacker Silicon SRE-PFL | Antifoam | 0.1% |
| Water | Filler | Add to 100% |

The BR 4.5 formulation was prepared by first making a millbase of BR 4.5. This is done by mixing partial amount of the water, Wacker Silicon SRE-PFL, Morwet D425, and Atlas G-5000 together until homogenous. Then BR 4.5 solid was added to the mixture and homogenized until uniformed. Then the sample was bead milled until the mean particle size of the BR 4.5 solid was approximately 2 μm. Next, the Xanthan Gum was prepared into a thickener solution by hydrating it into the remaining water and Acticide B20. Once the Xanthan Gum was fully hydrated, it was mixed into the BR 4.5 millbase and mixed until homogenous.

Results: BR3.81 treatment side showed a decrease in numbers of honey bees.

What is claimed is:

1. An insect repellent composition, wherein the insect is of the order Hymenoptera, the composition comprising:
a compound selected from Table 1, or a compound selected from Table 2, or a compound selected from Table 5, or any combination thereof, and
optionally at least one carrier vehicle, synergist and/or adjuvant suitable for use in an insect repellent.

2. The composition of claim 1, wherein the insect is a bee, wasp, or ant.

3. The composition of claim 1, wherein the insect is a honeybee or other pollinators.

4. The composition of any one of claims 1 to 3, wherein the compound is selected from Table 1 or Table 2.

5. The composition of any one of claims 1 to 3, wherein the compound is ethyl m-tolylacetate, 3-bromo-N-ethylbenzamide, N-(3-ethoxypropyl)(2-iodophenyl)carboxamide, ethyl 2-iodobenzoate, ethyl 2-(2,3-dihydro-1H-inden-1-yl)acetate, hexanophenone, phenyl 3-methoxypropanoate, 1-phenyl-3-hexanone, (2E)-1,3-diphenyl-2-buten-1-on, 1-(2,3-dihydro-1H-indol-1-yl)-3-ethoxy-1-propanone, 3-(3-pyridinyl)-1-(4-pyridinyl)-2-propen-1-one, or 2-isopropoxy-1,2-diphenylethanone, or any combination thereof.

6. The composition of any one of claims 1 to 5, wherein the compound has a volatility of no greater than about ten times more than the volatility of DEET.

7. The composition of any one of claims 1 to 6, wherein the compound is present at a concentration between 0.01 to 30% in the composition.

8. The composition of any one of claims 1 to 7, further comprising at least one insecticide, fungicide, herbicide, and/or seed treatment products.

9. The composition of claim 8, wherein:
(i) at least one insecticide comprises a compound selected from pyrethrum; Sodium Lauryl Sulfate; Rosemary Oil; Peppermint Oil; Thyme Oil; Cinnamon Oil; Garlic Oil; Clove Oil; Cedar Wood Oil; 1% Spearmint Oil; Neem Oil; Sumithrin; d-Phenothrin; Prallethrin; Deltamethrin; Fipronil; Hydramethylnon; Hydroprene; Methoprene; pyriproxyfen; Diatomaceous Earth; d-Phenothrin, N-Octyl Bicyclopheptene Dicarboximide; Imidacloprid, 1% n-Octyl bicycloheptene dicarboximide; d-Phenothrin; Clothianidin; Metofluthrin; (S)-methoprene; Pyriproxyfen; Flumethrin; Selamectin; Dinotefuran; Spinetoram; Fluralenar; Indozacarb; coumaphos; piperonyl butoxide; cyfluthrin; Acramite (bifenazate); Aldicarb; Asana XL (esfenvalerate); Bacillus thuringiensis (bacterium); Baythroid (cyfluthrin); Beta-cyfluthrin (pyrethyroid); Carbaryl (carbamate); carbofuran; Chlorpyrifos (organophosphate); Cruiser 5FS (thiamethoxam); Cygon 400 (dimethoate); Cythion 57% (malathion); Diazinon (organophosphate); Dibrom 8E; Dimethoate (organophosphate); Dimilin (diflubenzuron); Dipel 2X; Endosulfan (organochlorine); Esfenvalerate (pyrethroid); Fulfill (pymetrozine); Gama- and Lamda-cyhalothrin (pyrethroid); Guthion (azinphos methyl); Idoxacard (carboxylate); Imidan (phosmet); Kelthane (dicofol); Lanate (methomyl); Malathion (organophosphate); Metasystox-R; Methidathion (organophosphate); Methomyl (carbamate); Methoxychlor (methoxychlor); Methyl parathion (organophosphate); MSR (oxydemeton-methyl); Mustang Max (pyrethroid); Neemix; Nufos 4E (chlorpyrifos); Parathion 4E; Permethrin; Phosmet (organophosphate); Provado (imidacloprid); Pyrethrins; Sevin (carbaryl); Telfluthrin; Temik (aldicarb; terbufos; Thiodan (endosulfan); Vendex (hexakis fenbutatin-oxide); Warrior (organophosphate); Zeal (etoxazole); Zolone 3EC; Zeta-Cypermethrin; Sulfur; Spinosad (spinosyn A and spinosad D); Potassium Salts of Fatty Acids; Bifenthrin; cypermethrin; tebuconazole; tau-fluvalinate; carabryl; or insectidal soap; or a compound of a class of carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, or insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives, or any combination thereof; or
(ii) at least one herbicide from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, or ureas, or any combination thereof, or
(iii) at least one fungicide from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, or triazoles, or any combination thereof,
or any combinations of the foregoing.

10. The composition of any one of claims 1 to 9, wherein the composition is formulated or formatted as aerosol, bait, dust, dry flowable, emulsifiable concentrate, flowable, granule, microencapsulation, pellet, ready-to-use, soluble powder, ultra-low-volume concentrate, wettable powder, water-dispersible granule, oil-in-water emulsion, concentrated suspension, suspoemulsion, encapsulation and/or suspension mixture, oil dispersion, seed treatment suspension, seed coating, or dispersible concentrate.

11. The composition of any one of claims 1 to 9, wherein the composition is formulated as a spray, lotion, dust, paste, slow-release granules, paint, treated netting, treated building material, or incense.

12. The composition of any one of claims 1 to 11, wherein the composition is formulated for exposure using a vaporizer, evaporator, fan, heat, candle, or wicked apparatus.

13. A method of repelling an insect of the order Hymenoptera, comprising:
applying the composition of any one of claims 1 to 12 to a surface; or a crop, plant or flower, or any part thereof; or seeds, trees, or soil.

14. The method of claim 13, wherein the composition is applied by spraying, chemigation, coating, or injecting, or using in-furrow, drone, aerial applications or bait stations.

15. A method of repelling an insect of the order Hymenoptera, comprising:
exposing the insect to the composition of any one of claims 1 to 12 to repel the insect.

16. A method of protecting a crop or crop-containing area from crop-damaging pests while repelling an insect of the order Hymenoptera, the method comprising:
exposing the crop or crop-containing area to a composition of any one of claims 1 to 12, to repel the insect from making contact with harmful insecticides.

17. The method of any one of claims 13 to 16, wherein the crop is an agricultural crop.

18. The method of claim 17, wherein the agricultural crop is a flower, a tree, or a seed.

19. The method of any one of claims 13 to 18, wherein the crop is an agricultural crop that attracts bees.

20. The method of any one of claims 16 to 19, wherein the exposing step is carried out using a vaporizer, evaporator, fan, heat, candle, or wicked apparatus.

21. A method of identifying compounds that are repellent to an insect of the order Hymenoptera, comprising:
screening one or more compounds using one or more physiochemical descriptors selected from Table 3 to generate a molecular descriptor set for each of the one or more compounds;
calculating a repellency score using the molecular descriptor set; and
identifying compounds that are repellent to an insect of the order Hymenoptera based on the repellency score.

22. The method of claim 21, wherein the one or more compounds are screened computationally.

23. The method of claim 21 or 22, wherein the insect is a bee, wasp, or ant.

24. The method of claim 21 or 22, wherein the insect is a honeybee or other pollinators.

25. A system for repelling an insect of the order Hymenoptera, comprising:
a dispenser containing the composition of any one of claims 1 to 12.

26. The system of claim 25, wherein the dispenser is a spray or a canister.

27. An agricultural bee repellent composition, comprising:
a. a low volatility bee repellent compound; and
b. a high volatility bee repellent compound.

28. The composition of claim 27, wherein the bee repellent composition is formulated as a suspension concentrate (SC); emulsifiable concentrate (EC); wettable powder (WP); oil-in-water emulsion (EW); suspoemulsion (SE); capsule suspension (CS); mixed formulation (ZC) containing one or more active ingredients of a CS and SC; water-dispersible granule (WG); dispersible concentrate (DC); or oil dispersion (OD).

29. The composition of claim 27 or 28, wherein the ratio of low volatility bee repellent compound to high volatility bee repellent compound is from 1:99 to 99:1.

30. The composition of any one of claims 27-29, wherein the low volatility bee repellent compound is selected from ketones, amides, and anthranilates.

31. The composition of any one of claims 27-30, wherein the high volatility bee repellent compound is selected from ketones, amides, and anthranilates.

32. The composition of any one of claims 27-29, wherein the high volatility bee repellent compound is selected from the following:
Ethyl 2-iodobenzoate;
Phenyl 3-methoxypropanoate;
N,N-diethyl-meta-toluamide (DEET);
1-piperidinecarboxylic acid 2-(2-hydroxyethyl)-1-methylpropylester (Picaridin);
Phenylethylanthranilate;
Methyl-N-acetyl anthranilate;
4-(4-Hydroxy-2-methyl-3-quinolinyl)-2-butanone;
3-Ethyl-4-methyl-1-(2-propen-1-yl)-2(1H)-quinolinone;
4-(4-Hydroxy-2,6-dimethyl-3-quinolinyl)-2-butanone;
Ethyl-2,5-dimethyl-1-[2-(methylamino)-2-oxoethyl]-1H-pyrrole-3-carboxylate;
2-chloro-5-[[(2,2-dimethyl-1-oxopropyl) amino]methyl]-N-methyl-N-(2-methyl-2-propen-1-yl)-Benzamide;
3,4-Dihydro-N-methyl-4-oxo-3-propyl-1-phthalazine carboxamide;
N-3-Diethyl-3,4-dihydro-4-oxo-1-phthalazine carboxamide;
1-(4-(2-ethoxyphenyl)-1,2,3,4-tetrahydro-6-methyl-2-thioxo-5-pyrimidinyl)-ethanone;
1-(1,3-Dimethyl-1H-indol-2-yl)-1-butanone;
Phenyl-3-methoxy propanoate;
2-Pentyl-2-cyclopenten-1-one;
Methyl-2-ethenyl-3-pyridinecarboxylate;
1-Phenyl-3-hexanone;
Hexanophenone;
Valerophenone;
Ethyl-2-acetyl-3-pyridinecarboxylate;
rel-(1R,2R)-2-Ethoxycyclohexanol;
1-Methylindoline;
1-Phenyl-2-butanone;
Indoline;
3-methyl-ethylester-benzeneacetic acid;
Ethyl 2-(2,3-dihydro-1H-inden-1-yl)acetate
Ethyl m-Tolylacetate;
and
mixtures thereof.

33. The composition of any one of claims 27, 28, 29, or 32, wherein the low volatility bee repellent compound is selected from the following:
3-bromo-N-ethylbenzamide;
1-(2,3-Dihydro-1H-indol-1-yl)-3-ethoxy-1-propanone;
N-(3-ethoxypropyl)(2-iodophenyl)carboxamide;
N-Cyclohexylbenzamide;
Ethyl 2-(2-Cyanoanilino) acetate;
2-Isopropoxy-1,2-diphenylethanone; and
mixtures thereof.

34. The composition of claim 27, wherein high volatility bee repellent compound is ethyl 2-(2,3-dihydro-1H-inden-1-yl) acetate and the low volatility bee repellent compound is N-(3-ethoxypropyl)(2-iodophenyl)carboxamide or 2-Isopropoxy-1,2-diphenylethanone.

35. The composition of any one of claims 27, 28, 30, 31, 32, 33, or 34, wherein the ratio of low volatility bee repellent compound to high volatility bee repellent compound is about 1:1.

36. The composition of any one of claims 27, 29, 30, 31, 32, 33, 34, or 35, wherein the composition is a suspension concentrate (SC) or an emulsifiable concentrate (EC).

37. The composition of any one of claims 27-36, further comprising at least a carrier vehicle, synergist, additive, or adjuvant suitable for use in a bee repellent composition.

38. The composition of any one of claims 27-37, further comprising insecticide, fungicide, herbicide, and/or seed treatment products.

39. The composition of any one of claims 27-38, wherein the low volatility bee repellent compound has a volatility of no greater than about ten times more than the volatility of DEET.

40. The composition of any one of claims 27-39, wherein the high volatility bee repellent compound has a volatility of greater than about ten times more than the volatility of DEET.

41. An agricultural bee repellent composition, comprising:
c. a slow release agricultural bee repellent formulation, comprising a coated or encapsulated bee repellent compound; and
d. a high volatility bee repellent compound.

42. The composition of claim 41, wherein the high volatility bee repellent compound is selected from ketones, amides, and anthranilates.

43. The composition of claim 41, wherein the high volatility bee repellent compound is selected from the following:
Ethyl 2-iodobenzoate;
Phenyl 3-methoxypropanoate;
N,N-diethyl-meta-toluamide (DEET);
1-piperidinecarboxylic acid 2-(2-hydroxyethyl)-1-methylpropylester (Picaridin);
Phenylethylanthranilate;
Methyl-N-acetyl anthranilate;
4-(4-Hydroxy-2-methyl-3-quinolinyl)-2-butanone;
3-Ethyl-4-methyl-1-(2-propen-1-yl)-2(1H)-quinolinone;
4-(4-Hydroxy-2,6-dimethyl-3-quinolinyl)-2-butanone;
Ethyl-2,5-dimethyl-1-[2-(methylamino)-2-oxoethyl]-1H-pyrrole-3-carboxylate;
2-chloro-5-[[(2,2-dimethyl-1-oxopropyl) amino]methyl]-N-methyl-N-(2-methyl-2-propen-1-yl)-Benzamide;
3,4-Dihydro-N-methyl-4-oxo-3-propyl-1-phthalazine carboxamide;
N-3-Diethyl-3,4-dihydro-4-oxo-1-phthalazine carboxamide;
1-(4-(2-ethoxyphenyl)-1,2,3,4-tetrahydro-6-methyl-2-thioxo-5-pyrimidinyl)-ethanone;
1-(1,3-Dimethyl-1H-indol-2-yl)-1-butanone;
Phenyl-3-methoxy propanoate;
2-Pentyl-2-cyclopenten-1-one;
Methyl-2-ethenyl-3-pyridinecarboxylate;
1-Phenyl-3-hexanone;
Hexanophenone;
Valerophenone;
Ethyl-2-acetyl-3-pyridinecarboxylate;
rel-(1R,2R)-2-Ethoxycyclohexanol;
1-Methylindoline;
1-Phenyl-2-butanone;
Indoline;
3-methyl-ethylester-benzeneacetic acid;
Ethyl 2-(2,3-dihydro-1H-inden-1-yl)acetate
Ethyl m-Tolylacetate; and
mixtures thereof.

44. A slow release agricultural bee repellent composition, comprising a coated or encapsulated bee repellent compound.

45. The composition of claim 44, wherein the bee repellent compound is selected from ketones, amides, and anthranilates.

46. The composition of claim 44, wherein the bee repellent compound is selected from the following:
Ethyl 2-iodobenzoate;
Phenyl 3-methoxypropanoate;
N,N-diethyl-meta-toluamide (DEET);
1-piperidinecarboxylic acid 2-(2-hydroxyethyl)-1-methylpropylester (Picaridin);
Phenylethylanthranilate;
Methyl-N-acetyl anthranilate;
4-(4-Hydroxy-2-methyl-3-quinolinyl)-2-butanone;
3-Ethyl-4-methyl-1-(2-propen-1-yl)-2(1H)-quinolinone;
4-(4-Hydroxy-2,6-dimethyl-3-quinolinyl)-2-butanone;
Ethyl-2,5-dimethyl-1-[2-(methylamino)-2-oxoethyl]-1H-pyrrole-3-carboxylate;
2-chloro-5-[[(2,2-dimethyl-1-oxopropyl) amino]methyl]-N-methyl-N-(2-methyl-2-propen-1-yl)-Benzamide;
3,4-Dihydro-N-methyl-4-oxo-3-propyl-1-phthalazine carboxamide;
N-3-Diethyl-3,4-dihydro-4-oxo-1-phthalazine carboxamide;
1-(4-(2-ethoxyphenyl)-1,2,3,4-tetrahydro-6-methyl-2-thioxo-5-pyrimidinyl)-ethanone;
1-(1,3-Dimethyl-1H-indol-2-yl)-1-butanone;
Phenyl-3-methoxy propanoate;
2-Pentyl-2-cyclopenten-1-one;
Methyl-2-ethenyl-3-pyridinecarboxylate;
1-Phenyl-3-hexanone;
Hexanophenone;
Valerophenone;
Ethyl-2-acetyl-3-pyridinecarboxylate;
1-(2,3-Dihydro-1H-indol-1-yl)-3-ethoxy-1-propanone;
rel-(1R,2R)-2-Ethoxycyclohexanol;
1-Methylindoline;
1-Phenyl-2-butanone;
Indoline;
3-methyl-ethylester-benzeneacetic acid;
N-(3-ethoxypropyl)(2-iodophenyl)carboxamide;
Ethyl 2-(2,3-dihydro-1H-inden-1-yl)acetate
Ethyl m-Tolylacetate;
N-Cyclohexylbenzamide;
Ethyl 2-(2-Cyanoanilino) acetate;
2-Isopropoxy-1,2-diphenylethanone;
3-bromo-N-ethylbenzamide;
1-(2,3-Dihydro-1H-indol-1-yl)-3-ethoxy-1-propanone;
N-(3-ethoxypropyl)(2-iodophenyl)carboxamide;
N-Cyclohexylbenzamide;
Ethyl 2-(2-Cyanoanilino) acetate;
2-Isopropoxy-1,2-diphenylethanone; and
mixtures thereof.

47. A method for repelling bees from crops, comprising applying a bee repellent composition of any of claims 27-46 to a crop or a locus thereof.

48. The method of claim 47, wherein the bee repellent composition is applied to the crop during flowering.

49. The method of claim 47 or 48, wherein the method further comprises applying, to the crop or locus thereof, an insecticide, a fungicide, and/or a herbicide.
